(19) United States
(12) Patent Application Publication
(10) Pub. No.: US 2013/0210124 A1
(43) Pub. Date: Aug. 15, 2013

(54) DETERMINATION OF CANCER PREDISPOSITION

(71) Applicants: SANFORD- BURNHAM MEDICAL RESEARCH INSTITUTE, (US); Institut de Medicina Predictiva I Personalitzada Del Cancer (IMPPC), (US)

(72) Inventors: Manuel PERUCHO, San Diego, CA (US); Koichi SUZUKI, Omiya (JP); Sergio ALONSO, Tiana (ES)

(73) Assignees: Institut de Medicina Predictiva I Personalitzada Del Cancer (IMPPC), Barcelona (ES); SANFORD-BURNHAM MEDICAL RESEARCH INSTITUTE, La Jolla, CA (US)

(21) Appl. No.: 13/763,449

(22) Filed: Feb. 8, 2013

Related U.S. Application Data
(60) Provisional application No. 61/597,429, filed on Feb. 10, 2012.

(51) Int. Cl. G06F 19/00

(52) U.S. Cl. CPC G06F 19/34
USPC 435/287.2; 702/19

(57) ABSTRACT

Disclosed herein are systems and methods for using demethylation of genomic DNA for diagnosing, predicting, and/or monitoring the status or outcome of a neoplasm or a cancer in a subject.

### CROSS-REFERENCE

This application claims the benefit of U.S. Provisional Application No. 61/597,429, filed Feb. 10, 2012, which application is incorporated herein by reference.

### STATEMENT AS TO FEDERALLY SPONSORED RESEARCH

This invention was made with the support of the United States government under Grant number R37CA63585 by the NIH/NCI.

### SUMMARY OF THE INVENTION

In some embodiments, disclosed herein are methods of diagnosing, predicting, and/or monitoring the status or outcome of a neoplasm or a cancer in a subject in need thereof, comprising determining the relative demethylation level (RDL) of at least one genomic DNA repeat sequence in non-tumoral tissue from a subject as a marker for status or outcome of a neoplasm or cancer in the subject. In some embodiments, the method further comprises comparing the RDL with a reference RDL. In some embodiments, the method further comprises converting the RDL of the at least one genomic repeat sequence into a likelihood score that indicates the probability that the non-tumoral tissue is from a subject who will exhibit no evidence of the disease, who will have a single tumor, who will exhibit a neoplasm or cancer, and who will exhibit synchronous or metachronous tumors. In some embodiments, the method discriminates between healthy individuals having a low RDL, individuals having a single tumor with a low RDL, and individuals with multiple tumors (synchronous or metachronous) with a high RDL. In some embodiments, the RDL is determined by a method selected from the group consisting of: MethyLight, isulfate sequencing, combined isulfate restriction analysis, pyrosequencing, and DNA methylation arrays. In some embodiments, the genomic DNA repeat sequence is selected from the group consisting of: LINE-1, Sat-α, and SSTI. In some embodiments, determining the RDL comprises extracting genomic DNA from the non-tumoral tissue. In some embodiments, determining the RDL comprises amplifying the genomic DNA repeat sequence. In some embodiments, determining the RDL is based on a computer model or algorithm. In some embodiments, the method further comprises providing a computer generated report to the subject and/or health care provider. In some embodiments, the method further comprises transmitting a result to the subject and/or healthcare provider. In some embodiments, the method further comprises designing a therapeutic regimen based on the RDL. In some embodiments, the method further comprises treating or monitoring the subject based on the RDL. In some embodiments, treating or monitoring the cancer comprises predicting or prognosing patient outcome. In some embodiments, treating or monitoring the cancer comprises predicting likelihood of recurrence of a secondary tumor after removal of a primary tumor. In some embodiments, treating or monitoring the cancer comprises designating a surveillance regime or treatment modality. In some embodiments, treating or monitoring comprises designating cancer disease states. In some embodiments, the neoplasm or cancer is benign. In some embodiments, the neoplasm or cancer is an adenoma. In some embodiments, the neoplasm is malignant. In some embodiments, the non-tumoral tissue is blood. In some embodiments, the non-tumoral tissue is epithelial tissue. In some embodiments, the non-tumoral tissue is a needle-biopsy sample or surgical resection sample. In some embodiments, the non-tumoral tissue has been fixed in formalin and embedded in paraffin wax. In some embodiments, the neoplasm or cancer is a colon cancer. In some embodiments, the neoplasm or cancer has wild-type p53. In some embodiments, the colon cancer is a right-sided colon cancer. In some embodiments, the cancer is a gastric cancer. In some embodiments, the method further comprises analysis of the age of the subject.

Disclosed herein, in some embodiments, are systems for diagnosing, predicting, and/or monitoring the status or outcome of a neoplasm or a cancer in a subject in need thereof, comprising: (a) a computer processing device, optionally connected to a computer network; and (b) a software module executed by the computer processing device to compare the relative demethylation level (RDL) of a genomic DNA repeat sequence of the non-tumoral tissue to a standard or control. In some embodiments, the system further comprises a software module for generating a patient report. In some embodiments, the patient report comprises raw data, a diagnosis, a likelihood score, and/or a recommendation for surveillance or a therapeutic regimen. In some embodiments, the system further comprises non-tumoral tissue from the subject. In some embodiments, the system further comprises a DNA amplification device that quantifies the level of DNA with a light detection device. In some embodiments, the neoplasm or cancer comprises a primary tumor, wherein the non-tumoral tissue is adjacent to the primary tumor. In some embodiments, the neoplasm or cancer comprises synchronous tumors. In some embodiments, the genomic DNA repeat sequence is selected from the group consisting of: LINE-1, Sat-α, and SSTI.

Disclosed herein, in some embodiments, are systems for diagnosing, predicting, and/or monitoring the status or outcome of a neoplasm or a cancer in a subject in need thereof, comprising: (a) a primer complementary to a methylated or unmethylated sequence of a genomic DNA repeat sequence, wherein the primer sequence optionally reflects nucleotide conversion from isulfate treatment; or a probe complementary to a methylated or unmethylated sequence of a genomic DNA repeat sequence, wherein the probe sequence optionally reflects nucleotide conversion from isulfate treatment; and (b) a computer model or algorithm for analyzing the relative demethylation level (RDL) of the genomic DNA repeat sequence in non-tumoral tissue from the subject. In some embodiments, the system further comprises a computer model or algorithm for correlating RDL level with a disease state or outcome. In some embodiments, the disease state or outcome is the probability of synchronous or metachronous tumors. In some embodiments, the system further comprises a computer model or algorithm for designating a surveillance regime or treatment modality for the subject. In some embodiments, the system further comprises a computer readable medium for recording and storing the RDL levels. In some embodiments, the system further comprises a computer model or algorithm for normalizing the RDL of the genomic DNA repeat sequence. In some embodiments, the system further comprises a readable storage media comprising instructions executed by a computer device to compare the RDL levels to a control. In some embodiments, the system further comprises a computer system for transmitting a result to the subject and/or healthcare provider. In some embodiments, the system further comprises at least one device for detecting or quantifying the RDL levels. In some embodiments, the system further comprises a device for directly detecting, quantifying, and/or amplifying the genomic DNA repeat sequence. In some embodiments, the system further comprises a device that is a sequencer or electrophoresis apparatus. In some embodiments, the sequencer comprises single-molecule sequencing or bead-array technologies. In some embodiments, the system further comprises a device that extracts the genomic DNA repeat sequence from the non-tumoral tissue. In some embodiments, the non-tumoral tissue is blood. In some embodiments, the non-tumoral tissue is epithelial tissue. In some embodiments, the system further comprises a microscope, ultrasound machine, MRI machine, or a combination thereof. In some embodiments, the system further comprises a patient report, wherein the patient report comprises a representation of the RDL level of the genomic DNA repeat sequence. In some embodiments, the genomic DNA repeat sequence is selected from the group consisting of: LINE-1, Sat-α, and SSTI. In some embodiments, the subject is suffering from a cancer. In some embodiments, the neoplasm or cancer is a colon cancer. In some embodiments, the neoplasm or cancer has wild-type p53. In some embodiments, the colon cancer is a right-sided colon cancer. In some embodiments, the neoplasm or cancer is a gastric cancer. In some embodiments, the system further comprises analysis of the age of the subject.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a diagram exemplifying the study design.

FIG. 2 exemplifies how DNA hypomethylation correlates with patient age (a), especially from patients with tumors with wild type p53 (b). Hypomethylation alterations were identified by methylation-sensitive amplification length polymorphism (MS-AFLP) in a panel of 77 colorectal tumors and matching normal tissues. The mutational status of several genes (TP53, KRAS and BRAF) was determined in these tumor samples. P-values were calculated using the Pearson's product-moment correlation test.

FIG. 3 exemplifies how CC patients with multiple tumors were generally older than CC patients with single tumors. (a) Age of patients with single CC (in light grey) and patients with multiple tumors (synchronous or metachronous, in dark grey). Patients with multiple tumors were older than patients with single tumors (P=0.03, Student's t-test). (b) RDL of NCM of patients stratified according to their age (younger or older than the median population age, i.e. 70 years old). Older patients exhibited higher demethylation values (P=0.017, Mann-Whitney-Wilcoxon test). In both charts, horizontal lines represent median values.

FIG. 4 exemplifies how LINE-1 relative demethylation level in tumor and normal colonic mucosa of right-side colon cancer (CC) patients. (a) LINE-1 RDL in the tumor samples from 32 patients with single right-side CC (Single, in light grey) and 14 patients with right-side double synchronous cancers (Multiple, in dark grey). (b) LINE-1 RDL in the NCM samples from 75 patients with right-side single CC (Single, in light grey) and 24 patients who either presented right-side double synchronous colon cancers, or developed a second metachronous lesion within the following 8 years after surgical resection of the first cancer (Multiple, in dark grey). In all cases, the NCM LINE-1 RDL value refers to the normal tissue sample resected at the time of the initial surgery of the primary tumor. Differences between groups were analyzed by the non-parametric Mann-Whitney-Wilcoxon rank-sum test. Horizontal lines indicate the median value for each subgroup. The primers, probes and PCR conditions, as well as the MSI analysis are described in detail in Supplementary Table 1. P-values<0.01 are indicated in bold type.

FIG. 5 exemplifies a case-control study of metachronous tumor incidence in 76 patients with a single right-side colon cancer who underwent curative surgery. Ten of them developed a right-side metachronous neoplasm in the follow-up period (6-100 months). Patients were stratified into two groups (high and low) according to the LINE-1 RDL in the NCM, using three different thresholds: RDL>4, RDL>5 and RDL>6 (a, b and c, respectively), and metachronous tumor incidence was studied using the log rank test. Threshold 5 represents approximately the median of RDL values in the entire patient sample. The P-values, the number of cases above and below the cut-off, as well as the sensitivity and specificity of the classification are indicated for every employed cut-off. Cases with LINE-1 RDL higher than the stratification threshold (“high risk”) are represented with a solid black line, while cases with LINE-1 RDL lower than the stratification threshold (“low risk”) are represented by a dashed line. X-axis indicates the time after the surgical resection of the first lesion. Y-axis represents the proportion of patients who developed a second (metachronous) lesion in the right-side colon. Points in the curves correspond to censored cases. The results still retain statistically significance by applying Fisher Exact test (under the alternative hypothesis that true odds ratio is greater than 1) with an event at 36 months set as the endpoint: P=0.05 for cutoff of 4; P=0.015 for the RDL cutoff of 5; and P=0.045 for cutoff of 6.

FIG. 6 exemplifies the association between NCM LINE-1 RDL of single or multiple CC and patient age. LINE-1 RDL was analyzed in the NCM from 75 patients with single (in light grey) and 24 patients with multiple (in dark grey) right-side neoplasms. This latter group comprised 14 patients with synchronous double CCs and 10 patients who had a single cancer and developed a metachronous neoplasm in the following 8 years after surgical resection of the first lesion. Cases were categorized into younger (circles) and older (squares) according to the median age of the compared groups (68 for single tumor patients, 72.5 for multiple tumor patients and 70 for the entire sample population) (a) NCM RDL values of younger vs. older patients with a single neoplasm. (b) NCM RDL values of younger vs. older patients with multiple neoplasms. (c) NCM RDL values of younger patients with a single neoplasm vs. younger patients with multiple neoplasms. (d) NCM RDL values of older patients with a single neoplasm vs. older patients with multiple neoplasms. Horizontal lines indicate the median value for each subgroup. P-values were calculated using the non-parametric Mann-Whitney-Wilcoxon rank sum test. P-values<0.01 are represented in bold type.

FIG. 7 exemplifies the association between LINE-1 RDL in the normal colonic mucosa (NCM) and patient age exhibits a reverse trend in patients with a single colon cancer (CC) and patients with multiple (synchronous or metachronous) tumors. (a) In single CC patients the LINE-1 RDL increases in the NCM with patient age (slope m1=0.06, P=0.054), an observation that is consistent with the previously proposed ‘wear & tear’ model⁵. This trend, however, is reversed in patients with multiple CCs (slope m2=−0.14, P=0.083). P-values were calculated using the Pearson product-moment correlation coefficient test. (b) To assess whether the difference in slopes (D=m1−m2=0.2) was statistically significant, a bootstrapping test was performed with 100,000 random resamplings. In grey, the density histogram of the 100,000 estimated slopes differences obtained by the bootstrapping approach. The dashed line indicates the observed slope difference in the sample (D=0.2). The area on the right side of the dashed line corresponds to the proportion of randomly calculated slope differences larger than the observed slope difference (P=0.0092).

FIG. 8 exemplifies the area under curve (AUC) of this classification method is 0.743. The classification power of the method increases when age is also considered in combination with LINE1-RDL as risk factors.

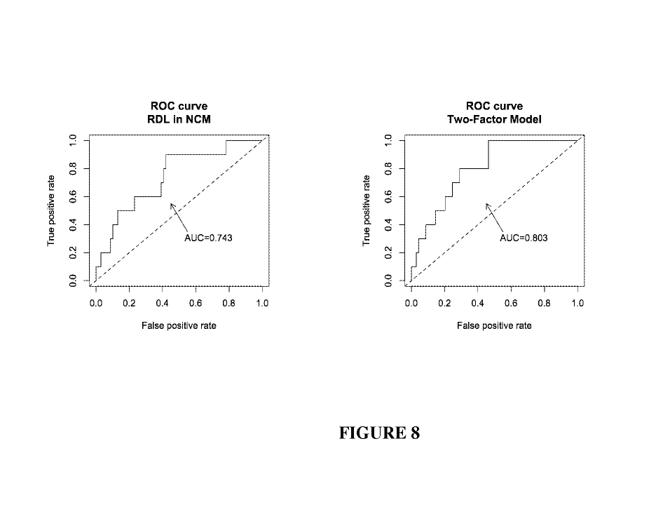

FIG. 9 exemplifies how the SAT α RDL in the NGM is significantly elevated in patients with synchronous double gastric cancer compared with single gastric cancer.

### DETAILED DESCRIPTION OF THE INVENTION

The present invention describes methods of using aberrant genomic DNA methylation patterns to diagnose, predict or monitor the progression of a disease or a condition (e.g., a cancer). In particular, the present invention relates to the use of using aberrant genomic DNA methylation patterns to diagnose, predict or monitor the status or outcome of neoplasms or cancers.

### DEFINITIONS

The term “cancer” as used herein, refers to any disease involving uncontrolled growth or proliferation cells in the human body. Cancers may further be characterized by the ability of cells to migrate from the original site and spread to distant sites (i.e., metastasize).

“Non-tumoral tissue” refers to a multiplicity of cells that are not currently in a cancerous state. Non-tumoral tissue can include cells of any type, including epithelial cells and lymphocytes. Non-tumoral tissue encompasses a combination of different cell types.

“Normal colon mucosa” or “NCM” refers to non-cancerous colon tissue. “Normal gastric mucosa” or “NGM” refers to non-cancerous gastric tissue.

### Cancer

The systems and methods disclosed herein may be used to diagnosis, monitor and/or predict the status or outcome of a cancer. As used herein, the “status of a neoplasm or cancer” includes the absence of a neoplasm or cancer. Generally, a cancer is characterized by the uncontrolled growth of abnormal cells anywhere in a body. The abnormal cells may be termed cancer cells, malignant cells, or tumor cells. Many cancers and the abnormal cells that compose the cancer tissue are further identified by the name of the tissue that the abnormal cells originated from (for example, breast cancer, lung cancer, colon cancer, prostate cancer, pancreatic cancer, thyroid cancer). Cancer is not confined to humans; animals and other living organisms can get cancer.

In some instances, a tumor may be malignant. Alternatively, a tumor may be benign.

The cancer may be a recurrent and/or refractory cancer. Most cancers can be classified as a carcinoma, sarcoma, leukemia, lymphoma, myeloma, or a central nervous system cancer.

The cancer may be a sarcoma. Sarcomas are cancers of the bone, cartilage, fat, muscle, blood vessels, or other connective or supportive tissue. Sarcomas include, but are not limited to, bone cancer, fibrosarcoma, chondrosarcoma, Ewing's sarcoma, malignant hemangioendothelioma, malignant schwannoma, bilateral vestibular schwannoma, osteosarcoma, soft tissue sarcomas (e.g. alveolar soft part sarcoma, angiosarcoma, cystosarcoma phylloides, dermatofibrosarcoma, isulfat tumor, epithelioid sarcoma, extraskeletal osteosarcoma, fibrosarcoma, hemangiopericytoma, hemangiosarcoma, Kaposi's sarcoma, leiomyosarcoma, liposarcoma, lymphangiosarcoma, lymphosarcoma, malignant fibrous histiocytoma, neurofibrosarcoma, rhabdomyosarcoma, and synovial sarcoma).

Alternatively, the cancer may be a carcinoma. Carcinomas are cancers that begin in the epithelial cells, which are cells that cover the surface of the body, produce hormones, and make up glands. By way of non-limiting example, carcinomas include breast cancer, pancreatic cancer, lung cancer, colon cancer, colorectal cancer, rectal cancer, kidney cancer, bladder cancer, stomach cancer, prostate cancer, liver cancer, ovarian cancer, brain cancer, vaginal cancer, vulvar cancer, uterine cancer, oral cancer, penic cancer, testicular cancer, esophageal cancer, skin cancer, cancer of the fallopian tubes, head and neck cancer, gastrointestinal stromal cancer, adenocarcinoma, cutaneous or intraocular melanoma, cancer of the anal region, cancer of the small intestine, cancer of the endocrine system, cancer of the thyroid gland, cancer of the parathyroid gland, cancer of the adrenal gland, cancer of the urethra, cancer of the renal pelvis, cancer of the ureter, cancer of the endometrium, cancer of the cervix, cancer of the pituitary gland, neoplasms of the central nervous system (CNS), primary CNS lymphoma, brain stem glioma, and spinal axis tumors. In some instances, the cancer is a skin cancer, such as a basal cell carcinoma, squamous, melanoma, nonmelanoma, or actinic (solar) keratosis. In some instances, the cancer is a prostate cancer. Alternatively, the cancer may be a thyroid cancer. The cancer can be a pancreatic cancer. In some instances, the cancer is a bladder cancer.

In some instances, the cancer is a lung cancer. Lung cancer can start in the airways that branch off the trachea to supply the lungs (bronchi) or the small air sacs of the lung (the alveoli). Lung cancers include non-small cell lung carcinoma (NSCLC), small cell lung carcinoma, and mesotheliomia. Examples of NSCLC include squamous cell carcinoma, adenocarcinoma, and large cell carcinoma. The mesothelioma may be a cancerous tumor of the lining of the lung and chest cavitity (pleura) or lining of the abdomen (peritoneum). The mesothelioma may be due to asbestos exposure. The cancer may be a brain cancer, such as a glioblastoma.

Alternatively, the cancer may be a central nervous system (CNS) tumor. CNS tumors may be classified as gliomas or nongliomas. The glioma may be malignant glioma, high grade glioma, diffuse intrinsic pontine glioma. Examples of gliomas include astrocytomas, oligodendrogliomas (or mixtures of oligodendroglioma and astocytoma elements), and ependymomas. Astrocytomas include, but are not limited to, low-grade astrocytomas, anaplastic astrocytomas, glioblastoma multiforme, pilocytic astrocytoma, pleomorphic xanthoastrocytoma, and subependymal giant cell astrocytoma. Oligodendrogliomas include low-grade oligodendrogliomas (or oligoastrocytomas) and anaplastic oligodendriogliomas. Nongliomas include meningiomas, pituitary adenomas, primary CNS lymphomas, and medulloblastomas. In some instances, the cancer is a meningioma.

The cancer may be a leukemia. The leukemia may be an acute lymphocytic leukemia, acute myelocytic leukemia, chronic lymphocytic leukemia, or chronic myelocytic leukemia. Additional types of leukemias include hairy cell leukemia, chronic myelomonocytic leukemia, and juvenile myelomonocytic-leukemia.

In some instances, the cancer is a lymphoma. Lymphomas are cancers of the lymphocytes and may develop from either B or T lymphocytes. The two major types of lymphoma are Hodgkin's lymphoma, previously known as Hodgkin's disease, and non-Hodgkin's lymphoma. Hodgkin's lymphoma is marked by the presence of the Reed-Sternberg cell. Non-Hodgkin's lymphomas are all lymphomas which are not Hodgkin's lymphoma. Non-Hodgkin lymphomas may be indolent lymphomas and aggressive lymphomas. Non-Hodgkin's lymphomas include, but are not limited to, diffuse large B cell lymphoma, follicular lymphoma, mucosa-associated lymphatic tissue lymphoma (MALT), small cell lymphocytic lymphoma, mantle cell lymphoma, Burkitt's lymphoma, mediastinal large B cell lymphoma, Waldenström macroglobulinemia, nodal marginal zone B cell lymphoma (NMZL), splenic marginal zone lymphoma (SMZL), extranodal marginal zone B cell lymphoma, intravascular large B cell lymphoma, primary effusion lymphoma, and lymphomatoid granulomatosis.

### Methods for Diagnosing and Analyzing Cancer

Disclosed herein, in some embodiments, is a method of diagnosing, predicting, and/or monitoring the status or outcome of a neoplasm or a cancer in a subject in need thereof, comprising determining the relative demethylation level (RDL) of at least one genomic DNA repeat sequence in non-tumoral tissue from a subject as a marker for status or outcome of a neoplasm or cancer in the subject. In some embodiments, the method further comprises comparing the RDL with a reference RDL. In some embodiments, the method further comprises converting the RDL of the at least one genomic repeat sequence into a likelihood score that indicates the probability that the non-tumoral tissue is from a subject who will exhibit no evidence of the disease, who will have a single tumor, who will exhibit a neoplasm or cancer, and who will exhibit synchronous or metachronous tumors. In some embodiments, the method further comprises designing a therapeutic regimen based on the RDL. In some embodiments, the method further comprises comprising treating or monitoring the subject based on the RDL. In some embodiments, treating or monitoring the cancer comprises prognosing patient outcome. In some embodiments, treating or monitoring the cancer comprises predicting likelihood of recurrence after removal of a tumor. In some embodiments, treating or monitoring the cancer comprises designating a surveillance regime or treatment modality. In some embodiments, treating or monitoring comprises designating cancer disease states. In some embodiments, the method further comprises analysis of the age of the subject. In some embodiments, a subject of greater than 70 years of age is at greater risk of developing a neoplasm or cancer.

In some embodiments, the diagnosing, predicting, and/or monitoring the status or outcome of a neoplasm or cancer comprises determining the malignancy of the cancer. In some embodiments, the diagnosing, predicting, and/or monitoring the status or outcome of a neoplasm or cancer includes determining the stage of the cancer. In some embodiments, the diagnosing, predicting, and/or monitoring the status or outcome of a neoplasm or cancer includes assessing the risk of cancer recurrence. In some embodiments, diagnosing, predicting, and/or monitoring the status or outcome of a neoplasm or cancer may comprise determining the efficacy of treatment. In some embodiments, diagnosing, predicting, and/or monitoring the status or outcome of a neoplasm or cancer may comprise determining a therapeutic regimen. Determining a therapeutic regimen may comprise administering an anti-cancer therapeutic. Alternatively, determining the treatment for the cancer may comprise modifying a therapeutic regimen. Modifying a therapeutic regimen may comprise increasing, decreasing, or terminating a therapeutic regimen. In some embodiments, diagnosing, treating or monitoring the cancer comprises prognosing patient outcome. In some embodiments, diagnosing, treating or monitoring the cancer comprises predicting likelihood of recurrence after removal of a tumor. In some embodiments, diagnosing, treating or monitoring the cancer comprises designating a surveillance regime or treatment modality. In some embodiments, a treatment modality includes administration of chemotherapy. In some embodiments, a treatment modality includes radiation treatment. In some embodiments, a treatment modality includes surgery.

In some embodiments, any genomic DNA repeat sequence can be used as a barometer for global DNA methylation levels in non-tumoral tissue. In some embodiments, the genomic DNA repeat sequence is a tandem repeat, such as satellite DNA, minisatellites, or microsatellites. In some embodiments, the genomic DNA repeat sequence is an interspersed repeat, such as a SINE or LINE sequence. In some embodiments, the genomic DNA repeat sequence is selected from the group consisting of: LINE-1, Sat-α, Alu sequences, and SST1 sequences.

In some embodiments, the method further comprises comparing the RDL or a genomic DNA repeat sequence with a reference RDL. In some embodiments, the reference RDL is from a healthy individual. In some embodiments, the reference RDL is compiled from a population of healthy individuals.

In some embodiments, the non tumoral tissue is a needle-biopsy sample or surgical resection sample. In some embodiments, the sample has been fixed in formalin and embedded in paraffin wax. In some embodiments, the non-tumoral tissue is a blood sample. In some embodiments, the non-tumoral tissue comprises blood cells isolated from a blood sample. In some embodiments, the non-tumoral tissue is epithelial tissue. In some embodiments, the non-tumoral tissue is adjacent to a primary tumor. In some embodiments, the non-tumoral tissue is less than 10 cm from the primary tumor.

In some embodiments, determining the RDL comprises amplifying the genomic DNA repeat sequence.

In some embodiments, determining the RDL comprises extracting genomic DNA from the sample.

In some embodiments, determining the RDL of a genomic DNA repeat sequence comprises sequencing the repeat sequence. In some, embodiments, determining the RDL of a genomic DNA repeat sequence does not comprise sequencing the repeat sequence. In some embodiments, determining the RDL comprises employing a primer complementary to a methylated or unmethylated target sequence of a genomic DNA repeat sequence, wherein the methylated or unmethylated target sequence optionally reflects nucleotide conversion from isulfate treatment. In some embodiments, the RDL is determined by a method selected from the group consisting of: MethyLight, isulfate sequencing, combined isulfate restriction analysis, pyrosequencing, and DNA methylation arrays.

In some embodiments, the method further comprises providing a computer generated report to the subject and/or health care provider.

In some embodiments, the method further comprises transmitting a result to the subject and/or healthcare provider.

In some embodiments, determining the RDL is based on a computer model or algorithm.

In some embodiments, the neoplasm or cancer is benign. In some embodiments, the neoplasm or cancer is an adenoma.

In some embodiments, the subject is suffering from a cancer. In some embodiments, the cancer has wild-type p53.

In some embodiments, the cancer is a gastric cancer.

In some embodiments, the cancer is a colon cancer. In some embodiments, the colon cancer is a right-sided colon cancer. In some embodiments, the colon cancer is a left-sided colon cancer. In some embodiments, the colon cancer has synchronous tumors. In some embodiments, the colon cancer will develop metachronous tumors.

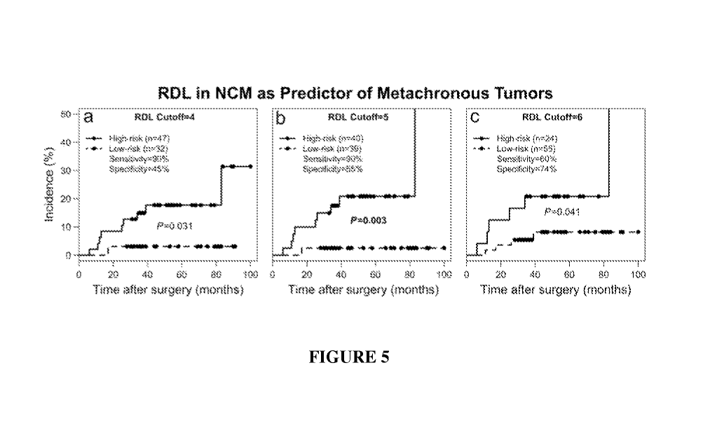

In some embodiments, disclosed herein is a method of estimating the risk of right-side colonic synchronous cancers and the risk to develop metachronous colonic neoplasms after right-side colectomy based on the quantitative determination of the relative demethylation levels (RDL) of LINE-1 sequences (LINE1-RDL) in the non-tumoral colonic mucosa from sporadic colorectal cancer patients. The present invention exemplifies how DNA hypomethylation assessed by LINE-1 RDL in NCM is useful for stratification of non-HNPCC patients into ‘low’ and ‘high’ risk groups for subsequent development of metachronous neoplasms with high sensitivity (FIG. 5). Further, the present invention provides evidence for the existence of two distinct roles of DNA demethylation in CC development: 1) a gradual demethylation associated to single cancers in old patients generally without mutant p53, and 2) a more drastic demethylation undergone by relatively younger patients possibly underlying a field cancerization effect for the development of multiple neoplasms. The present invention also indicates that the enhanced demethylation observed in NCM of patients with multiple CC not only underlies a field cancerization effect that predisposes to cancer development, but also that this defect is due to an inherited susceptibility.

### Cancer Staging

Diagnosing, predicting, or monitoring a status or outcome of a cancer may comprise determining the stage of the cancer. Generally, the stage of a cancer is a description (usually numbers I to IV with IV having more progression) of the extent the cancer has spread. The stage often takes into account the size of a tumor, how deeply it has penetrated, whether it has invaded adjacent organs, how many lymph nodes it has metastasized to (if any), and whether it has spread to distant organs. Staging of cancer can be used as a predictor of survival, and cancer treatment may be determined by staging. Determining the stage of the cancer may occur before, during, or after treatment. The stage of the cancer may also be determined at the time of diagnosis.

Cancer staging can be divided into a clinical stage and a pathologic stage. Cancer staging may comprise the TNM classification. Generally, the TNM Classification of Malignant Tumours (TNM) is a cancer staging system that describes the extent of cancer in a patient's body. T may describe the size of the tumor and whether it has invaded nearby tissue, N may describe regional lymph nodes that are involved, and M may describe distant metastasis (spread of cancer from one body part to another). In the TNM (Tumor, Node, Metastasis) system, clinical stage and pathologic stage are denoted by a small “c” or “p” before the stage (e.g., cT3N1M0 or pT2N0).

Often, clinical stage and pathologic stage may differ. Clinical stage may be based on all of the available information obtained before a surgery to remove the tumor. Thus, it may include information about the tumor obtained by physical examination, radiologic examination, and endoscopy. Pathologic stage can add additional information gained by examination of the tumor microscopically by a pathologist. Pathologic staging can allow direct examination of the tumor and its spread, contrasted with clinical staging which may be limited by the fact that the information is obtained by making indirect observations at a tumor which is still in the body. The TNM staging system can be used for most forms of cancer.

Alternatively, staging may comprise Ann Arbor staging. Generally, Ann Arbor staging is the staging system for lymphomas, both in Hodgkin's lymphoma (previously called Hodgkin's disease) and Non-Hodgkin lymphoma (abbreviated NHL). The stage may depend on both the place where the malignant tissue is located (as located with biopsy, CT scanning and increasingly positron emission tomography) and on systemic symptoms due to the lymphoma (“B symptoms”: night sweats, weight loss of >10% or fevers). The principal stage may be determined by location of the tumor. Stage I may indicate that the cancer is located in a single region, usually one lymph node and the surrounding area. Stage I often may not have outward symptoms. Stage II can indicate that the cancer is located in two separate regions, an affected lymph node or organ and a second affected area, and that both affected areas are confined to one side of the diaphragm—that is, both are above the diaphragm, or both are below the diaphragm. Stage III often indicates that the cancer has spread to both sides of the diaphragm, including one organ or area near the lymph nodes or the spleen. Stage IV may indicate diffuse or disseminated involvement of one or more extralymphatic organs, including any involvement of the liver, bone marrow, or nodular involvement of the lungs.

Modifiers may also be appended to some stages. For example, the letters A, B, E, X, or S can be appended to some stages. Generally, A or B may indicate the absence of constitutional (B-type) symptoms is denoted by adding an “A” to the stage; the presence is denoted by adding a “B” to the stage. E can be used if the disease is “extranodal” (not in the lymph nodes) or has spread from lymph nodes to adjacent tissue. X is often used if the largest deposit is >10 cm large (“bulky disease”), or whether the mediastinum is wider than ⅓ of the chest on a chest X-ray. S may be used if the disease has spread to the spleen.

The nature of the staging may be expressed with CS or PS. CS may denote that the clinical stage as obtained by doctor's examinations and tests. PS may denote that the pathological stage as obtained by exploratory laparotomy (surgery performed through an abdominal incision) with splenectomy (surgical removal of the spleen).

### Additional Techniques and Tests

Factors known in the art for diagnosing and/or suggesting, selecting, designating, recommending or otherwise determining a course of treatment for a patient or class of patients suspected of having cancer can be employed in combination with RDL determinations. The methods disclosed herein may include additional techniques such as cytology, histology, ultrasound analysis, MRI results, CT scan results, and measurements of biological molecules specific to a class of cancers (i.e., PSA levels for prostate cancer).

Certified tests for classifying disease status and/or designating treatment modalities may also be used in diagnosing, predicting, and/or monitoring the status or outcome of a cancer in a subject. A certified test may comprise a means for characterizing the RDL of a genomic DNA repeat sequence, and a certification from a government regulatory agency endorsing use of the test for classifying the disease status of a biological sample.

In some embodiments, the certified test may comprise reagents for amplification reactions used to detect and/or quantitate expression of the target sequences to be characterized in the test. An array of probe nucleic acids can be used, with or without prior target amplification, for use in measuring target sequence expression.

The test is submitted to an agency having authority to certify the test for use in distinguishing disease status and/or outcome. Results of detection of RDL levels of genomic DNA repeat sequences used in the test and correlation with disease status and/or outcome are submitted to the agency. A certification authorizing the diagnostic and/or prognostic use of the test is obtained.

Also provided are portfolios of RDLs of genomic DNA repeat sequences. Such portfolios may be provided by performing the methods described herein to obtain RDLs from an individual patient or from a group of patients. The RDLs can be normalized by any method known in the art; exemplary normalization methods that can be used in various embodiments include Robust Multichip Average (RMA), probe logarithmic intensity error estimation (PLIER), non-linear fit (NLFIT) quantile-based and nonlinear normalization, and combinations thereof. Background correction can also be performed on the RDL data; exemplary techniques useful for background correction include mode of intensities, normalized using median polish probe modeling and sketch-normalization.

The invention also encompasses the above methods where the RDL determines the status or outcome of a cancer in the subject with at least about 45% specificity. In some embodiments, the RDL determines the status or outcome of a cancer in the subject with at least about 50% specificity. In some embodiments, the RDL determines the status or outcome of a cancer in the subject with at least about 55% specificity. In some embodiments, the RDL determines the status or outcome of a cancer in the subject with at least about 60% specificity. In some embodiments, the RDL determines the status or outcome of a cancer in the subject with at least about 65% specificity. In some embodiments, the RDL determines the status or outcome of a cancer in the subject with at least about 70% specificity. In some embodiments, the RDL determines the status or outcome of a cancer in the subject with at least about 75% specificity. In some embodiments, the RDL determines the status or outcome of a cancer in the subject with at least about 80% specificity. In some embodiments, t the RDL determines the status or outcome of a cancer in the subject with at least about 85% specificity. In some embodiments, the RDL determines the status or outcome of a cancer in the subject with at least about 90% specificity. In some embodiments, the RDL determines the status or outcome of a cancer in the subject with at least about 95% specificity.

The invention also encompasses the any of the methods disclosed herein where the accuracy of diagnosing, monitoring, and/or predicting a status or outcome of a cancer is at least about 45%. In some embodiments, the accuracy of diagnosing, monitoring, and/or predicting a status or outcome of a cancer is at least about 50%. In some embodiments, the accuracy of diagnosing, monitoring, and/or predicting a status or outcome of a cancer is at least about 55%. In some embodiments, the accuracy of diagnosing, monitoring, and/or predicting a status or outcome of a cancer is at least about 60%. In some embodiments, the accuracy of diagnosing, monitoring, and/or predicting a status or outcome of a cancer is at least about 65%. In some embodiments, the accuracy of diagnosing, monitoring, and/or predicting a status or outcome of a cancer is at least about 70%. In some embodiments, the accuracy of diagnosing, monitoring, and/or predicting a status or outcome of a cancer is at least about 75%. In some embodiments, the accuracy of diagnosing, monitoring, and/or predicting a status or outcome of a cancer is at least about 80%. In some embodiments, the accuracy of diagnosing, monitoring, and/or predicting a status or outcome of a cancer is at least about 85%. In some embodiments, the accuracy of diagnosing, monitoring, and/or predicting a status or outcome of a cancer is at least about 90%. In some embodiments, the accuracy of diagnosing, monitoring, and/or predicting a status or outcome of a cancer is at least about 95%.

The invention also encompasses the any of the methods disclosed herein where the sensitivity is at least about 45%. In some embodiments, the sensitivity is at least about 50%. In some embodiments, the sensitivity is at least about 55%. In some embodiments, the sensitivity is at least about 60%. In some embodiments, the sensitivity is at least about 65%. In some embodiments, the sensitivity is at least about 70%. In some embodiments, the sensitivity is at least about 75%. In some embodiments, the sensitivity is at least about 80%. In some embodiments, the sensitivity is at least about 85%. In some embodiments, the sensitivity is at least about 90%. In some embodiments, the sensitivity is at least about 95%.

### Therapeutic Regimens

Diagnosing, predicting, or monitoring a status or outcome of a cancer may comprise treating a cancer or preventing a cancer progression. In addition, diagnosing, predicting, or monitoring a status or outcome of a cancer may comprise identifying or predicting responders to an anti-cancer therapy. In some instances, diagnosing, predicting, or monitoring may comprise determining a therapeutic regimen. Determining a therapeutic regimen may comprise administering an anti-cancer therapy. Alternatively, determining a therapeutic regimen may comprise modifying, recommending, continuing or discontinuing an anti-cancer regimen. In some instances, if the sample expression patterns are consistent with the expression pattern for a known disease or disease outcome, the expression patterns can be used to designate one or more treatment modalities (e.g., therapeutic regimens, anti-cancer regimen). An anti-cancer regimen may comprise one or more anti-cancer therapies. Examples of anti-cancer therapies include surgery, chemotherapy, radiation therapy, immunotherapy/biological therapy, photodynamic therapy.

Surgical oncology uses surgical methods to diagnose, stage, and treat cancer, and to relieve certain cancer-related symptoms. Surgery may be used to remove the tumor (e.g., excisions, resections, debulking surgery), reconstruct a part of the body (e.g., restorative surgery), and/or to relieve symptoms such as pain (e.g., palliative surgery). Surgery may also include cryosurgery. Cryosurgery (also called cryotherapy) may use extreme cold produced by liquid nitrogen (or argon gas) to destroy abnormal tissue. Cryosurgery can be used to treat external tumors, such as those on the skin. For external tumors, liquid nitrogen can be applied directly to the cancer cells with a cotton swab or spraying device. Cryosurgery may also be used to treat tumors inside the body (internal tumors and tumors in the bone). For internal tumors, liquid nitrogen or argon gas may be circulated through a hollow instrument called a cryoprobe, which is placed in contact with the tumor. An ultrasound or MRI may be used to guide the cryoprobe and monitor the freezing of the cells, thus limiting damage to nearby healthy tissue. A ball of ice crystals may form around the probe, freezing nearby cells. Sometimes more than one probe is used to deliver the liquid nitrogen to various parts of the tumor. The probes may be put into the tumor during surgery or through the skin (percutaneously). After cryosurgery, the frozen tissue thaws and may be naturally absorbed by the body (for internal tumors), or may dissolve and form a scab (for external tumors).

Chemotherapeutic agents may also be used for the treatment of cancer. Examples of chemotherapeutic agents include alkylating agents, anti-metabolites, plant alkaloids and terpenoids, vinca alkaloids, podophyllotoxin, taxanes, topoisomerase inhibitors, and cytotoxic antibiotics. Cisplatin, carboplatin, and oxaliplatin are examples of alkylating agents. Other alkylating agents include mechlorethamine, cyclophosphamide, chlorambucil, ifosfamide. Alkylating agens may impair cell function by forming covalent bonds with the amino, carboxyl, sulfhydryl, and phosphate groups in biologically important molecules. Alternatively, alkylating agents may chemically modify a cell's DNA.

Anti-metabolites are another example of chemotherapeutic agents. Anti-metabolites may masquerade as purines or pyrimidines and may prevent purines and pyrimidines from becoming incorporated in to DNA during the “S” phase (of the cell cycle), thereby stopping normal development and division. Antimetabolites may also affect RNA synthesis. Examples of metabolites include azathioprine and mercaptopurine.

Alkaloids may be derived from plants and block cell division may also be used for the treatment of cancer. Alkyloids may prevent microtubule function. Examples of alkaloids are vinca alkaloids and taxanes. Vinca alkaloids may bind to specific sites on tubulin and inhibit the assembly of tubulin into microtubules (M phase of the cell cycle). The vinca alkaloids may be derived from the Madagascar periwinkle, Catharanthus roseus (formerly known as Vinca rosea). Examples of vinca alkaloids include, but are not limited to, vincristine, vinblastine, vinorelbine, or vindesine. Taxanes are diterpenes produced by the plants of the genus Taxus (yews). Taxanes may be derived from natural sources or synthesized artificially. Taxanes include paclitaxel (Taxol) and docetaxel (Taxotere). Taxanes may disrupt microtubule function. Microtubules are essential to cell division, and taxanes may stabilize GDP-bound tubulin in the microtubule, thereby inhibiting the process of cell division. Thus, in essence, taxanes may be mitotic inhibitors. Taxanes may also be radiosensitizing and often contain numerous chiral centers.

Alternative chemotherapeutic agents include podophyllotoxin. Podophyllotoxin is a plant-derived compound that may help with digestion and may be used to produce cytostatic drugs such as etoposide and teniposide. They may prevent the cell from entering the G1 phase (the start of DNA replication) and the replication of DNA (the S phase).

Topoisomerases are essential enzymes that maintain the topology of DNA. Inhibition of type I or type II topoisomerases may interfere with both transcription and replication of DNA by upsetting proper DNA supercoiling. Some chemotherapeutic agents may inhibit topoisomerases. For example, some type I topoisomerase inhibitors include camptothecins: irinotecan and topotecan. Examples of type II inhibitors include amsacrine, etoposide, etoposide phosphate, and teniposide.

Another example of chemotherapeutic agents is cytotoxic antibiotics. Cytotoxic antibiotics are a group of antibiotics that are used for the treatment of cancer because they may interfere with DNA replication and/or protein synthesis. Cytotoxic antiobiotics include, but are not limited to, actinomycin, anthracyclines, doxorubicin, daunorubicin, valrubicin, idarubicin, epirubicin, bleomycin, plicamycin, and mitomycin.

In some instances, the anti-cancer treatment may comprise radiation therapy. Radiation can come from a machine outside the body (external-beam radiation therapy) or from radioactive material placed in the body near cancer cells (internal radiation therapy, more commonly called brachytherapy). Systemic radiation therapy uses a radioactive substance, given by mouth or into a vein that travels in the blood to tissues throughout the body.

External-beam radiation therapy may be delivered in the form of photon beams (either x-rays or gamma rays). A photon is the basic unit of light and other forms of electromagnetic radiation. An example of external-beam radiation therapy is called 3-dimensional conformal radiation therapy (3D-CRT). 3D-CRT may use computer software and advanced treatment machines to deliver radiation to very precisely shaped target areas. Many other methods of external-beam radiation therapy are currently being tested and used in cancer treatment. These methods include, but are not limited to, intensity-modulated radiation therapy (IMRT), image-guided radiation therapy (IGRT), Stereotactic radiosurgery (SRS), Stereotactic body radiation therapy (SBRT), and proton therapy.

Intensity-modulated radiation therapy (IMRT) is an example of external-beam radiation and may use hundreds of tiny radiation beam-shaping devices, called collimators, to deliver a single dose of radiation. The collimators can be stationary or can move during treatment, allowing the intensity of the radiation beams to change during treatment sessions. This kind of dose modulation allows different areas of a tumor or nearby tissues to receive different doses of radiation. IMRT is planned in reverse (called inverse treatment planning). In inverse treatment planning, the radiation doses to different areas of the tumor and surrounding tissue are planned in advance, and then a high-powered computer program calculates the required number of beams and angles of the radiation treatment. In contrast, during traditional (forward) treatment planning, the number and angles of the radiation beams are chosen in advance and computers calculate how much dose may be delivered from each of the planned beams. The goal of IMRT is to increase the radiation dose to the areas that need it and reduce radiation exposure to specific sensitive areas of surrounding normal tissue.

Another example of external-beam radiation is image-guided radiation therepy (IGRT). In IGRT, repeated imaging scans (CT, MRI, or PET) may be performed during treatment. These imaging scans may be processed by computers to identify changes in a tumor's size and location due to treatment and to allow the position of the patient or the planned radiation dose to be adjusted during treatment as needed. Repeated imaging can increase the accuracy of radiation treatment and may allow reductions in the planned volume of tissue to be treated, thereby decreasing the total radiation dose to normal tissue.

Tomotherapy is a type of image-guided IMRT. A tomotherapy machine is a hybrid between a CT imaging scanner and an external-beam radiation therapy machine. The part of the tomotherapy machine that delivers radiation for both imaging and treatment can rotate completely around the patient in the same manner as a normal CT scanner. Tomotherapy machines can capture CT images of the patient's tumor immediately before treatment sessions, to allow for very precise tumor targeting and sparing of normal tissue.

Stereotactic radiosurgery (SRS) can deliver one or more high doses of radiation to a small tumor. SRS uses extremely accurate image-guided tumor targeting and patient positioning. Therefore, a high dose of radiation can be given without excess damage to normal tissue. SRS can be used to treat small tumors with well-defined edges. It is most commonly used in the treatment of brain or spinal tumors and brain metastases from other cancer types. For the treatment of some brain metastases, patients may receive radiation therapy to the entire brain (called whole-brain radiation therapy) in addition to SRS. SRS requires the use of a head frame or other device to immobilize the patient during treatment to ensure that the high dose of radiation is delivered accurately.

Stereotactic body radiation therapy (SBRT) delivers radiation therapy in fewer sessions, using smaller radiation fields and higher doses than 3D-CRT in most cases. SBRT may treat tumors that lie outside the brain and spinal cord. Because these tumors are more likely to move with the normal motion of the body, and therefore cannot be targeted as accurately as tumors within the brain or spine, SBRT is usually given in more than one dose. SBRT can be used to treat small, isolated tumors, including cancers in the lung and liver. SBRT systems may be known by their brand names, such as the CyberKnife®.

In proton therapy, external-beam radiation therapy may be delivered by proton. Protons are a type of charged particle. Proton beams differ from photon beams mainly in the way they deposit energy in living tissue. Whereas photons deposit energy in small packets all along their path through tissue, protons deposit much of their energy at the end of their path (called the Bragg peak) and deposit less energy along the way. Use of protons may reduce the exposure of normal tissue to radiation, possibly allowing the delivery of higher doses of radiation to a tumor.

Other charged particle beams such as electron beams may be used to irradiate superficial tumors, such as skin cancer or tumors near the surface of the body, but they cannot travel very far through tissue.

Internal radiation therapy (brachytherapy) is radiation delivered from radiation sources (radioactive materials) placed inside or on the body. Several brachytherapy techniques are used in cancer treatment. Interstitial brachytherapy may use a radiation source placed within tumor tissue, such as within a prostate tumor. Intracavitary brachytherapy may use a source placed within a surgical cavity or a body cavity, such as the chest cavity, near a tumor. Episcleral brachytherapy, which may be used to treat melanoma inside the eye, may use a source that is attached to the eye. In brachytherapy, radioactive isotopes can be sealed in tiny pellets or “seeds.” These seeds may be placed in patients using delivery devices, such as needles, catheters, or some other type of carrier. As the isotopes decay naturally, they give off radiation that may damage nearby cancer cells. Brachytherapy may be able to deliver higher doses of radiation to some cancers than external-beam radiation therapy while causing less damage to normal tissue.

Brachytherapy can be given as a low-dose-rate or a high-dose-rate treatment. In low-dose-rate treatment, cancer cells receive continuous low-dose radiation from the source over a period of several days. In high-dose-rate treatment, a robotic machine attached to delivery tubes placed inside the body may guide one or more radioactive sources into or near a tumor, and then removes the sources at the end of each treatment session. High-dose-rate treatment can be given in one or more treatment sessions. An example of a high-dose-rate treatment is the MammoSite® system. Bracytherapy may be used to treat patients with breast cancer who have undergone breast-conserving surgery.

The placement of brachytherapy sources can be temporary or permanent. For permament brachytherapy, the sources may be surgically sealed within the body and left there, even after all of the radiation has been given off. In some instances, the remaining material (in which the radioactive isotopes were sealed) does not cause any discomfort or harm to the patient. Permanent brachytherapy is a type of low-dose-rate brachytherapy. For temporary brachytherapy, tubes (catheters) or other carriers are used to deliver the radiation sources, and both the carriers and the radiation sources are removed after treatment. Temporary brachytherapy can be either low-dose-rate or high-dose-rate treatment. Brachytherapy may be used alone or in addition to external-beam radiation therapy to provide a “boost” of radiation to a tumor while sparing surrounding normal tissue.

In systemic radiation therapy, a patient may swallow or receive an injection of a radioactive substance, such as radioactive iodine or a radioactive substance bound to a monoclonal antibody. Radioactive iodine (131I) is a type of systemic radiation therapy commonly used to help treat cancer, such as thyroid cancer. Thyroid cells naturally take up radioactive iodine. For systemic radiation therapy for some other types of cancer, a monoclonal antibody may help target the radioactive substance to the right place. The antibody joined to the radioactive substance travels through the blood, locating and killing tumor cells. For example, the drug ibritumomab tiuxetan (Zevalin®) may be used for the treatment of certain types of B-cell non-Hodgkin lymphoma (NHL). The antibody part of this drug recognizes and binds to a protein found on the surface of B lymphocytes. The combination drug regimen of tositumomab and iodine I 131 tositumomab (Bexxar®) may be used for the treatment of certain types of cancer, such as NHL. In this regimen, nonradioactive tositumomab antibodies may be given to patients first, followed by treatment with tositumomab antibodies that have 131I attached. Tositumomab may recognize and bind to the same protein on B lymphocytes as ibritumomab. The nonradioactive form of the antibody may help protect normal B lymphocytes from being damaged by radiation from 131I.

Some systemic radiation therapy drugs relieve pain from cancer that has spread to the bone

(bone metastases). This is a type of palliative radiation therapy. The radioactive drugs samarium-153-lexidronam (Quadramet®) and strontium-89 chloride (Metastron®) are examples of radiopharmaceuticals may be used to treat pain from bone metastases.

Biological therapy (sometimes called immunotherapy, biotherapy, or biological response modifier (BRM) therapy) uses the body's immune system, either directly or indirectly, to fight cancer or to lessen the side effects that may be caused by some cancer treatments. Biological therapies include interferons, interleukins, colony-stimulating factors, monoclonal antibodies, vaccines, gene therapy, and nonspecific immunomodulating agents.

Interferons (IFNs) are types of cytokines that occur naturally in the body. Interferon alpha, interferon beta, and interferon gamma are examples of interferons that may be used in cancer treatment.

Like interferons, interleukins (IlS) are cytokines that occur naturally in the body and can be made in the laboratory. Many interleukins have been identified for the treatment of cancer. For example, interleukin-2 (IL-2 or aldesleukin), interleukin 7, and interleukin 12 have may be used as an anti-cancer treatment. IL-2 may stimulate the growth and activity of many immune cells, such as lymphocytes, that can destroy cancer cells. Interleukins may be used to treat a number of cancers, including leukemia, lymphoma, and brain, colorectal, ovarian, breast, kidney and prostate cancers.

Colony-stimulating factors (CSFs) (sometimes called hematopoietic growth factors) may also be used for the treatment of cancer. Some examples of CSFs include, but are not limited to, G-CSF (filgrastim) and GM-CSF (sargramostim). CSFs may promote the division of bone marrow stem cells and their development into white blood cells, platelets, and red blood cells. Bone marrow is critical to the body's immune system because it is the source of all blood cells. Because anticancer drugs can damage the body's ability to make white blood cells, red blood cells, and platelets, stimulation of the immune system by CSFs may benefit patients undergoing other anti-cancer treatment, thus CSFs may be combined with other anti-cancer therapies, such as chemotherapy. CSFs may be used to treat a large variety of cancers, including lymphoma, leukemia, multiple myeloma, melanoma, and cancers of the brain, lung, esophagus, breast, uterus, ovary, prostate, kidney, colon, and rectum.

Another type of biological therapy includes monoclonal antibodies (MOABs or MoABs). These antibodies may be produced by a single type of cell and may be specific for a particular antigen. To create MOABs, a human cancer cells may be injected into mice. In response, the mouse immune system can make antibodies against these cancer cells. The mouse plasma cells that produce antibodies may be isolated and fused with laboratory-grown cells to create “hybrid” cells called hybridomas. Hybridomas can indefinitely produce large quantities of these pure antibodies, or MOABs. MOABs may be used in cancer treatment in a number of ways. For instance, MOABs that react with specific types of cancer may enhance a patient's immune response to the cancer. MOABs can be programmed to act against cell growth factors, thus interfering with the growth of cancer cells.

MOABs may be linked to other anti-cancer therapies such as chemotherapeutics, radioisotopes (radioactive substances), other biological therapies, or other toxins. When the antibodies latch onto cancer cells, they deliver these anti-cancer therapies directly to the tumor, helping to destroy it. MOABs carrying radioisotopes may also prove useful in diagnosing certain cancers, such as colorectal, ovarian, and prostate.

Rituxan® (rituximab) and Herceptin® (trastuzumab) are examples of MOABs that may be used as a biological therapy. Rituxan may be used for the treatment of non-Hodgkin lymphoma. Herceptin can be used to treat metastatic breast cancer in patients with tumors that produce excess amounts of a protein called HER2. Alternatively, MOABs may be used to treat lymphoma, leukemia, melanoma, and cancers of the brain, breast, lung, kidney, colon, rectum, ovary, prostate, and other areas.

Cancer vaccines are another form of biological therapy. Cancer vaccines may be designed to encourage the patient's immune system to recognize cancer cells. Cancer vaccines may be designed to treat existing cancers (therapeutic vaccines) or to prevent the development of cancer (prophylactic vaccines). Therapeutic vaccines may be injected in a person after cancer is diagnosed. These vaccines may stop the growth of existing tumors, prevent cancer from recurring, or eliminate cancer cells not killed by prior treatments. Cancer vaccines given when the tumor is small may be able to eradicate the cancer. On the other hand, prophylactic vaccines are given to healthy individuals before cancer develops. These vaccines are designed to stimulate the immune system to attack viruses that can cause cancer. By targeting these cancer-causing viruses, development of certain cancers may be prevented. For example, cervarix and gardasil are vaccines to treat human papilloma virus and may prevent cervical cancer. Therapeutic vaccines may be used to treat melanoma, lymphoma, leukemia, and cancers of the brain, breast, lung, kidney, ovary, prostate, pancreas, colon, and rectum. Cancer vaccines can be used in combination with other anti-cancer therapies.

Gene therapy is another example of a biological therapy. Gene therapy may involve introducing genetic material into a person's cells to fight disease. Gene therapy methods may improve a patient's immune response to cancer. For example, a gene may be inserted into an immune cell to enhance its ability to recognize and attack cancer cells. In another approach, cancer cells may be injected with genes that cause the cancer cells to produce cytokines and stimulate the immune system.

In some instances, biological therapy includes nonspecific immunomodulating agents. Nonspecific immunomodulating agents are substances that stimulate or indirectly augment the immune system. Often, these agents target key immune system cells and may cause secondary responses such as increased production of cytokines and immunoglobulins. Two nonspecific immunomodulating agents used in cancer treatment are bacillus Calmette-Guerin (BCG) and levamisole. BCG may be used in the treatment of superficial bladder cancer following surgery. BCG may work by stimulating an inflammatory, and possibly an immune, response. A solution of BCG may be instilled in the bladder. Levamisole is sometimes used along with fluorouracil (5-FU) chemotherapy in the treatment of stage III (Dukes' C) colon cancer following surgery. Levamisole may act to restore depressed immune function.

Photodynamic therapy (PDT) is an anti-cancer treatment that may use a drug, called a photosensitizer or photosensitizing agent, and a particular type of light. When photosensitizers are exposed to a specific wavelength of light, they may produce a form of oxygen that kills nearby cells. A photosensitizer may be activated by light of a specific wavelength. This wavelength determines how far the light can travel into the body. Thus, photosensitizers and wavelengths of light may be used to treat different areas of the body with PDT.

In the first step of PDT for cancer treatment, a photosensitizing agent may be injected into the bloodstream. The agent may be absorbed by cells all over the body but may stay in cancer cells longer than it does in normal cells. Approximately 24 to 72 hours after injection, when most of the agent has left normal cells but remains in cancer cells, the tumor can be exposed to light. The photosensitizer in the tumor can absorb the light and produces an active form of oxygen that destroys nearby cancer cells. In addition to directly killing cancer cells, PDT may shrink or destroy tumors in two other ways. The photosensitizer can damage blood vessels in the tumor, thereby preventing the cancer from receiving necessary nutrients. PDT may also activate the immune system to attack the tumor cells.

The light used for PDT can come from a laser or other sources. Laser light can be directed through fiber optic cables (thin fibers that transmit light) to deliver light to areas inside the body. For example, a fiber optic cable can be inserted through an endoscope (a thin, lighted tube used to look at tissues inside the body) into the lungs or esophagus to treat cancer in these organs. Other light sources include light-emitting diodes (LEDs), which may be used for surface tumors, such as skin cancer. PDT is usually performed as an outpatient procedure. PDT may also be repeated and may be used with other therapies, such as surgery, radiation, or chemotherapy.

Extracorporeal photopheresis (ECP) is a type of PDT in which a machine may be used to collect the patient's blood cells. The patient's blood cells may be treated outside the body with a photosensitizing agent, exposed to light, and then returned to the patient. ECP may be used to help lessen the severity of skin symptoms of cutaneous T-cell lymphoma that has not responded to other therapies. ECP may be used to treat other blood cancers, and may also help reduce rejection after transplants.

Additionally, photosensitizing agent, such as porfimer sodium or Photofrin®, may be used in PDT to treat or relieve the symptoms of esophageal cancer and non-small cell lung cancer. Porfimer sodium may relieve symptoms of esophageal cancer when the cancer obstructs the esophagus or when the cancer cannot be satisfactorily treated with laser therapy alone. Porfimer sodium may be used to treat non-small cell lung cancer in patients for whom the usual treatments are not appropriate, and to relieve symptoms in patients with non-small cell lung cancer that obstructs the airways. Porfimer sodium may also be used for the treatment of precancerous lesions in patients with Barrett esophagus, a condition that can lead to esophageal cancer.

Laser therapy may use high-intensity light to treat cancer and other illnesses. Lasers can be used to shrink or destroy tumors or precancerous growths. Lasers are most commonly used to treat superficial cancers (cancers on the surface of the body or the lining of internal organs) such as basal cell skin cancer and the very early stages of some cancers, such as cervical, penile, vaginal, vulvar, and non-small cell lung cancer.

Lasers may also be used to relieve certain symptoms of cancer, such as bleeding or obstruction. For example, lasers can be used to shrink or destroy a tumor that is blocking a patient's trachea (windpipe) or esophagus. Lasers also can be used to remove colon polyps or tumors that are blocking the colon or stomach.

Laser therapy is often given through a flexible endoscope (a thin, lighted tube used to look at tissues inside the body). The endoscope is fitted with optical fibers (thin fibers that transmit light). It is inserted through an opening in the body, such as the mouth, nose, anus, or vagina. Laser light is then precisely aimed to cut or destroy a tumor.

Laser-induced interstitial thermotherapy (LITT), or interstitial laser photocoagulation, also uses lasers to treat some cancers. LITT is similar to a cancer treatment called hyperthermia, which uses heat to shrink tumors by damaging or killing cancer cells. During LITT, an optical fiber is inserted into a tumor. Laser light at the tip of the fiber raises the temperature of the tumor cells and damages or destroys them. LITT is sometimes used to shrink tumors in the liver.

Laser therapy can be used alone, but most often it is combined with other treatments, such as surgery, chemotherapy, or radiation therapy. In addition, lasers can seal nerve endings to reduce pain after surgery and seal lymph vessels to reduce swelling and limit the spread of tumor cells.

Lasers used to treat cancer may include carbon dioxide (CO2) lasers, argon lasers, and neodymium:yttrium-aluminum-garnet (Nd:YAG) lasers. Each of these can shrink or destroy tumors and can be used with endoscopes. CO2 and argon lasers can cut the skin's surface without going into deeper layers. Thus, they can be used to remove superficial cancers, such as skin cancer. In contrast, the Nd:YAG laser is more commonly applied through an endoscope to treat internal organs, such as the uterus, esophagus, and colon. Nd:YAG laser light can also travel through optical fibers into specific areas of the body during LITT. Argon lasers are often used to activate the drugs used in PDT.

For patients with high test scores consistent with systemic disease outcome after prostatectomy, additional treatment modalities such as adjuvant chemotherapy (e.g., docetaxel, mitoxantrone and prednisone), systemic radiation therapy (e.g., samarium or strontium) and/or anti-androgen therapy (e.g., surgical castration, finasteride, dutasteride) can be designated. Such patients would likely be treated immediately with anti-androgen therapy alone or in combination with radiation therapy in order to eliminate presumed micro-metastatic disease, which cannot be detected clinically but can be revealed by the genomic DNA repeat sequence expression signature.

Such patients can also be more closely monitored for signs of disease progression. For patients with intermediate test scores consistent with biochemical recurrence only (BCR-only or elevated PSA that does not rapidly become manifested as systemic disease only localized adjuvant therapy (e.g., radiation therapy of the prostate bed) or short course of anti-androgen therapy would likely be administered. For patients with low scores or scores consistent with no evidence of disease (NED) adjuvant therapy would not likely be recommended by their physicians in order to avoid treatment-related side effects such as metabolic syndrome (e.g., hypertension, diabetes and/or weight gain), osteoporosis, proctitis, incontinence or impotence. Patients with samples consistent with NED could be designated for watchful waiting, or for no treatment. Patients with test scores that do not correlate with systemic disease but who have successive PSA increases could be designated for watchful waiting, increased monitoring, or lower dose or shorter duration anti-androgen therapy.

Genomic DNA repeat sequences can be grouped so that information obtained about the set of genomic DNA repeat sequences in the group can be used to make or assist in making a clinically relevant judgment such as a diagnosis, prognosis, or treatment choice.

A patient report is also provided comprising a representation of measured RDLs of a plurality of genomic DNA repeat sequences in a biological sample from the patient. The patient report may be provided in a machine (e.g., a computer) readable format and/or in a hard (paper) copy. The report can also include standard measurements of RDLs of genomic DNA repeat sequences from one or more sets of patients with known disease status and/or outcome. The report can be used to inform the patient and/or treating physician of the RDLs of the genomic DNA repeat sequences, the likely medical diagnosis and/or implications, and optionally may recommend a treatment modality for the patient.

### Systems for Diagnosing and Analyzing Cancer

Disclosed herein, in some embodiments, is system for diagnosing, predicting, and/or monitoring the status or outcome of a neoplasm or a cancer in a subject in need thereof, comprising: (a) a computer processing device, optionally connected to a computer network; and (b) a software module executed by the computer processing device to compare the relative demethylation level (RDL) of a genomic DNA repeat sequence of the non-tumoral tissue to a standard or control. In some embodiments, the system further comprises a software module for generating a patient report. In some embodiments, the patient report comprises raw data, a diagnosis, a likelihood score, and/or a recommendation for surveillance or a therapeutic regimen. In some embodiments, the system further comprises non-tumoral tissue from the subject. In some embodiments, the system further comprises a DNA amplification device (i.e., a PCR machine) that quantifies the level of DNA with a light detection device.

Disclosed herein, in some embodiments, is a system for diagnosing, predicting, and/or monitoring the status or outcome of a neoplasm or a cancer in a subject in need thereof, comprising: (a) a primer complementary to a methylated or unmethylated sequence of a genomic DNA repeat sequence, wherein the primer sequence optionally reflects nucleotide conversion from isulfate treatment; or a probe complementary to a methylated or unmethylated sequence of a genomic DNA repeat sequence, wherein the probe sequence optionally reflects nucleotide conversion from isulfate treatment; and (b) a computer model or algorithm for analyzing the relative demethylation level (RDL) of the genomic DNA repeat sequence in non-tumoral tissue from the subject. In some embodiments, the system further comprises a computer model or algorithm for correlating RDL level with a disease state or outcome. In some embodiments, the method further comprises analysis of the age of the subject. In some embodiments, a subject of greater than 70 years of age is at greater risk of developing a neoplasm or cancer. In some embodiments, the system further comprises a computer module to combine the RDL with analysis of the age of the subject.

In some embodiments, the subject is suffering from a cancer. In some embodiments, the cancer has wild-type p53.

In some embodiments, the cancer is a gastric cancer.

In some embodiments, the cancer is a colon cancer. In some embodiments, the colon cancer is a right-sided colon cancer. In some embodiments, the colon cancer is a left-sided colon cancer. In some embodiments, the colon cancer has synchronous tumors. In some embodiments, the colon cancer will develop metachronous tumors.

In some embodiments, any genomic DNA repeat sequence can be used as a barometer for global DNA methylation levels in non-tumoral tissue. In some embodiments, the genomic DNA repeat sequence is a tandem repeat, such as satellite DNA, minisatellites, or microsatellites. In some embodiments, the genomic DNA repeat sequence is an interspersed repeat, such as a SINE or LINE sequence. In some embodiments, the genomic DNA repeat sequence is selected from the group consisting of: LINE-1, Sat-α, Alu sequences, and SST1 sequences.

In some embodiments, determining the RDL of a genomic DNA repeat sequence comprises sequencing the repeat sequence. In some, embodiments, determining the RDL of a genomic DNA repeat sequence does not comprise sequencing the repeat sequence. In some embodiments, determining the RDL comprises employing a primer complementary to a methylated or unmethylated target sequence of a genomic DNA repeat sequence, wherein the methylated or unmethylated target sequence optionally reflects nucleotide conversion from isulfate treatment. In some embodiments, the RDL is determined by a method selected from the group consisting of: MethyLight, isulfate sequencing, combined isulfate restriction analysis, pyrosequencing; and DNA methylation arrays.

In some embodiments, the system further comprises a computer model or algorithm for correlating RDL level with a disease state or outcome. In some embodiments, the disease state or outcome is the probability of synchronous or metachronous tumors. In some embodiments, the system further comprises a computer model or algorithm for designating a surveillance regime or treatment modality for the subject. In some embodiments, the system further comprises a computer readable medium for recording and storing the RDL levels. In some embodiments, the system further comprises a computer model or algorithm for normalizing the RDL of a genomic DNA repeat sequence. In some embodiments, the system further comprises a readable storage media comprising instructions executed by a computer device to compare the RDL levels to a control. In some embodiments, the system further comprises a computer system for transmitting a result to the subject and/or healthcare provider.

In some embodiments, the non tumoral tissue is a needle-biopsy sample or surgical resection sample. In some embodiments, the sample has been fixed in formalin and embedded in paraffin wax. In some embodiments, the non-tumoral tissue is a blood sample. In some embodiments, the non-tumoral tissue comprises blood cells isolated from a blood sample. In some embodiments, the non-tumoral tissue is epithelial tissue. In some embodiments, the non-tumoral tissue is adjacent to a primary tumor. In some embodiments, the non-tumoral tissue is less than 10 cm from the primary tumor.

In some embodiments, the system further comprises a device for directly detecting, quantifying, and/or amplifying the genomic DNA repeat sequence. In some embodiments, the system further comprises a device that is a sequencer or electrophoresis apparatus. In some embodiments, the device comprises single-molecule sequencing or bead-array technologies. In some embodiments, the system further comprises a device that extracts the genomic DNA repeat sequence from the non-tumoral tissue. In some embodiments, the system further comprises a microscope, ultrasound machine, MRI machine, or a combination thereof.

In some embodiments, the system further comprises a patient report, wherein the patient report comprises a representation of the RDL level of the genomic DNA repeat sequence.

In some embodiments, the system further comprises at least one device for detecting or quantifying the RDL levels. Devices useful for performing methods of the invention are also provided. The devices can comprise means for characterizing the RDL of a genomic DNA repeat sequence of the invention, for example components for performing one or more methods of nucleic acid extraction, amplification, and/or detection. Such components may include one or more of an amplification chamber (for example a thermal cycler), a plate reader, a spectrophotometer, capillary electrophoresis apparatus, a chip reader, and or robotic sample handling components. These components ultimately can obtain data that reflects the RDL of the genomic DNA repeat sequences used in the assay being employed.

The devices may include an excitation and/or a detection means. Any instrument that provides a wavelength that can excite a species of interest and is shorter than the emission wavelength(s) to be detected can be used for excitation. Commercially available devices can provide suitable excitation wavelengths as well as suitable detection component.

Exemplary excitation sources include a broadband UV light source such as a deuterium lamp with an appropriate filter, the output of a white light source such as a xenon lamp or a deuterium lamp after passing through a monochromator to extract out the desired wavelength(s), a continuous wave (cw) gas laser, a solid state diode laser, or any of the pulsed lasers. Emitted light can be detected through any suitable device or technique; many suitable approaches are known in the art. For example, a fluorimeter or spectrophotometer may be used to detect whether the test sample emits light of a wavelength characteristic of a label used in an assay.

The devices typically comprise a means for identifying a given sample, and of linking the results obtained to that sample. Such means can include manual labels, barcodes, and other indicators which can be linked to a sample vessel, and/or may optionally be included in the sample itself, for example where an encoded particle is added to the sample. The results may be linked to the sample, for example in a computer memory that contains a sample designation and a record of RDLs obtained from the sample. Linkage of the results to the sample can also include a linkage to a particular sample receptacle in the device, which is also linked to the sample identity.

The devices also comprise a means for correlating the RDL of the genomic DNA repeat sequences being studied with a prognosis of disease outcome. Such means may comprise one or more of a variety of correlative techniques, including lookup tables, algorithms, multivariate models, and linear or nonlinear combinations of expression models or algorithms. The RDLs may be converted to one or more likelihood scores, reflecting a likelihood that the patient providing the sample may exhibit a particular disease outcome. The models and/or algorithms can be provided in machine readable format and can optionally further designate a treatment modality for a patient or class of patients.

The device also comprises output means for outputting the disease status, prognosis and/or a treatment modality. Such output means can take any form which transmits the results to a patient and/or a healthcare provider, and may include a monitor, a printed format, or both. The device may use a computer system for performing one or more of the steps provided.

The methods disclosed herein may also comprise the transmission of data/information. For example, data/information derived from the detection and/or quantification of the target may be transmitted to another device and/or instrument. In some instances, the information obtained from an algorithm may also be transmitted to another device and/or instrument. Transmission of the data/information may comprise the transfer of data/information from a first source to a second source. The first and second sources may be in the same approximate location (e.g., within the same room, building, block, campus). Alternatively, first and second sources may be in multiple locations (e.g., multiple cities, states, countries, continents, etc).

Transmission of the data/information may comprise digital transmission or analog transmission. Digital transmission may comprise the physical transfer of data (a digital bit stream) over a point-to-point or point-to-multipoint communication channel. Examples of such channels are copper wires, optical fibres, wireless communication channels, and storage media. The data may be represented as an electromagnetic signal, such as an electrical voltage, radiowave, microwave, or infrared signal.

Analog transmission may comprise the transfer of a continuously varying analog signal. The messages can either be represented by a sequence of pulses by means of a line code (baseband transmission), or by a limited set of continuously varying wave forms (passband transmission), using a digital modulation method. The passband modulation and corresponding demodulation (also known as detection) can be carried out by modem equipment. According to the most common definition of digital signal, both baseband and passband signals representing bit-streams are considered as digital transmission, while an alternative definition only considers the baseband signal as digital, and passband transmission of digital data as a form of digital-to-analog conversion.

### Data Analysis

In some embodiments, one or more pattern recognition methods can be used in analyzing the RDL of genomic DNA repeat sequences. The pattern recognition method can comprise a linear combination of RDLs, or a nonlinear combination of RDLs. In some embodiments, expression measurements for RNA transcripts or combinations of RNA transcript levels are formulated into linear or non-linear models or algorithms (e.g., an ‘expression signature’) and converted into a likelihood score. This likelihood score indicates the probability that a biological sample is from a patient who may exhibit no evidence of disease, who may exhibit systemic cancer, or who may exhibit biochemical recurrence. The likelihood score can be used to distinguish these disease states. The models and/or algorithms can be provided in machine readable format, and may be used to correlate an RDL or an RDL profile with a disease state, and/or to designate a treatment modality for a patient or class of patients.

Assaying the RDL may comprise the use of an algorithm or classifier. Array data can be managed, classified, and analyzed using techniques known in the art. Assaying the RDL for a plurality of targets may comprise probe set modeling and data pre-processing. Probe set modeling and data pre-processing can be derived using the Robust Multi-Array (RMA) algorithm or variants GC-RMA, fRMA, Probe Logarithmic Intensity Error (PLIER) algorithm or variant iterPLIER. Variance or intensity filters can be applied to pre-process data using the RMA algorithm, for example by removing target sequences with a standard deviation of <10 or a mean intensity of <100 intensity units of a normalized data range, respectively.

Alternatively, assaying the RDL for a plurality of targets may comprise the use of a machine learning algorithm. The machine learning algorithm may comprise a supervised learning algorithm. Examples of supervised learning algorithms may include Average One-Dependence Estimators (AODE), Artificial neural network (e.g., Backpropagation), Bayesian statistics (e.g., I Bayes classifier, Bayesian network, Bayesian knowledge base), Case-based reasoning, Decision trees, Inductive logic programming, Gaussian process regression, Group method of data handling (GMDH), Learning Automata, Learning Vector Quantization, Minimum message length (decision trees, decision graphs, etc.), Lazy learning, Instance-based learning Nearest Neighbor Algorithm, Analogical modeling, Probably approximately correct learning (PAC) learning, Ripple down rules, a knowledge acquisition methodology, Symbolic machine learning algorithms, Subsymbolic machine learning algorithms, Support vector machines, Random Forests, Ensembles of classifiers, Bootstrap aggregating (bagging), and Boosting. Supervised learning may comprise ordinal classification such as regression analysis and Information fuzzy networks (IFN). Alternatively, supervised learning methods may comprise statistical classification, such as AODE, Linear classifiers (e.g., Fisher's linear discriminant, Logistic regression, I Bayes classifier, Perceptron, and Support vector machine), quadratic classifiers, k-nearest neighbor, Boosting, Decision trees (e.g., C4.5, Random forests), Bayesian networks, and Hidden Markov models.

The machine learning algorithms may also comprise an unsupervised learning algorithm. Examples of unsupervised learning algorithms may include Artificial neural network, Data clustering, Expectation-maximization algorithm, Self-organizing map, Radial basis function network, Vector Quantization, Generative topographic map, Information bottleneck method, and IBSEAD. Unsupervised learning may also comprise association rule learning algorithms such as Apriori algorithm, Eclat algorithm and FP-growth algorithm. Hierarchical clustering, such as Single-linkage clustering and Conceptual clustering, may also be used. Alternatively, unsupervised learning may comprise partitional clustering such as K-means algorithm and Fuzzy clustering.

In some instances, the machine learning algorithms comprise a reinforcement learning algorithm. Examples of reinforcement learning algorithms include, but are not limited to, Temporal difference learning, Q-learning and Learning Automata. Alternatively, the machine learning algorithm may comprise Data Pre-processing.

Preferably, the machine learning algorithms may include, but are not limited to, Average One-Dependence Estimators (AODE), Fisher's linear discriminant, Logistic regression, Perceptron, Multilayer Perceptron, Artificial Neural Networks, Support vector machines, Quadratic classifiers, Boosting, Decision trees, C4.5, Bayesian networks, Hidden Markov models, High-Dimensional Discriminant Analysis, and Gaussian Mixture Models. The machine learning algorithm may comprise support vector machines, Naïve Bayes classifier, k-nearest neighbor, high-dimensional discriminant analysis, or Gaussian mixture models. In some instances, the machine learning algorithm comprises Random Forests.

### Kits

Disclosed herein, in some embodiments, is a kit for analyzing a neoplasm or a cancer in a subject in need thereof, comprising a primer complementary to a methylated or unmethylated target sequence of a genomic DNA repeat sequence, wherein the methylated or unmethylated target sequence optionally reflects nucleotide conversion from isulfate treatment. In some embodiments, the kit further comprises a computer model or algorithm for analyzing the relative demethylation level (RDL) of the genomic DNA repeat sequence in non-tumoral tissue from the subject. In some embodiments, the subject is suffering from cancer. In some embodiments, the kit further comprises a computer model or algorithm for correlating RDL level with a disease state or outcome. In some embodiments, the disease state or outcome is the probability of synchronous or metachronous tumors. In some embodiments, the kit further comprises a computer model or algorithm for designating a surveillance regime or treatment modality for the subject. In some embodiments, the kit further comprises a computer readable medium for recording and storing the RDL levels. In some embodiments, the kit further comprises a computer model or algorithm for normalizing the RDL of the genomic DNA repeat sequence. In some embodiments, the kit further comprises a readable storage media comprising instructions executed by a computer device to compare the RDL levels to a control. In some embodiments, the kit further comprises a computer kit for transmitting a result to the subject and/or healthcare provider. In some embodiments, the kit further comprises at least one device for detecting or quantifying the RDL levels. In some embodiments, the kit further comprises a device for directly detecting, quantifying, and/or amplifying the genomic DNA repeat sequence. In some embodiments, the kit further comprises a device that is a sequencer or electrophoresis apparatus. In some embodiments, the sequencer comprises single-molecule sequencing or bead-array technologies. In some embodiments, the kit further comprises a device that extracts the genomic DNA repeat sequence from the non-tumoral tissue. In some embodiments, the non-tumoral tissue is blood. In some embodiments, the non-tumoral tissue is epithelial tissue. In some embodiments, the kit further comprises a microscope, ultrasound machine, MRI machine, or a combination thereof. In some embodiments, the kit further comprises a patient report, wherein the patient report comprises a representation of the RDL level of the genomic DNA repeat sequence. In some embodiments, the genomic DNA repeat sequence is selected from the group consisting of: LINE-1, Sat-α, and SSTI. In some embodiments, the neoplasm or cancer is a colon cancer. In some embodiments, the colon cancer is a right-sided colon cancer. In some embodiments, the neoplasm or cancer is a gastric cancer.

### EXAMPLES

### Example 1

### LINE-1 RDL in Colon Cancer

### Patients and Samples

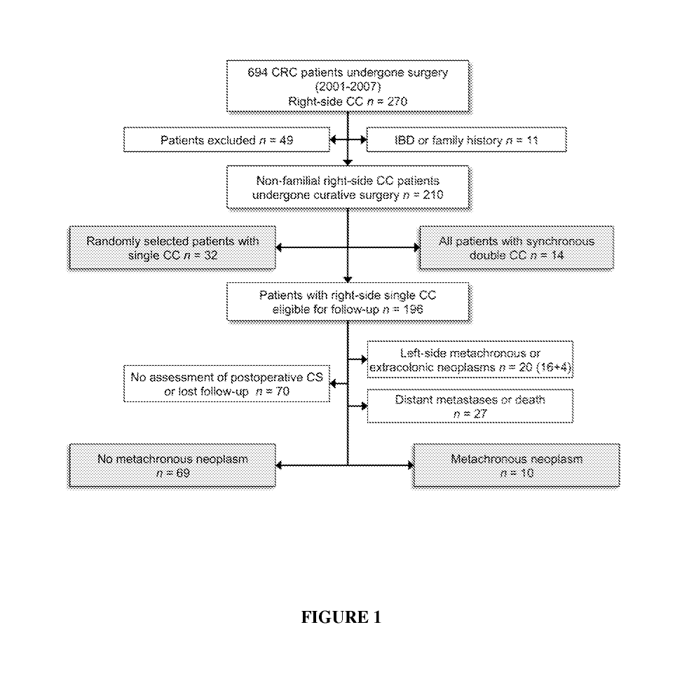

Tumor tissues and corresponding NCM were obtained from patients with CC who underwent surgery from May 2001 to February 2007 at the Saitama Medical Center, Jichi Medical University. The samples of normal-appearing right-sided colonic mucosa from 11 patients without malignant disease (healthy volunteers) were obtained from biopsy specimens collected during screening colonoscopies and from resected specimens from patients with diverticulitis and appendicitis. This study was approved by the Research Ethics Committee and written informed consent was obtained from each participant. A diagram of the study design is shown in FIG. 1. From 694 total CC patients those with right sided colon cancers (n=270) were selected. Of the right side CCs, 211 underwent curative surgery after excluding 49 patients: 22 patients with insufficient clinical information, 15 patients with three or more CC and 3 patients with 1CC+1ADE, 8 patients enrolled in a different study, and 1 patient suspected to have HNPCC (45 years old female MSI positive). To minimize the confounding factor of multiple cancers due to hereditary predisposition factors such as familial polyposis (FAP) or non-polyposis colorectal cancer (HNPCC) or inflammatory bowel disease, 11 additional cases were also excluded. Of the final 196 eligible patients, 14 had double cancers, and for comparison a random set of 32 patients with single cancers were selected, in addition to 11 healthy volunteers. The 32 patients with single cancers matched the overall population of single CC bearing patients in regards to age (68.3±7.7 vs. 66.7±11.3, P=0.31, Student's t-test), in addition to location. See Table 1.

TABLE 1
Clinico-pathological and demographic data.

| | | 694 CC | 270 right-side CC | | | CC | Single | Synch. | Metachr. |
|---|---|---|---|---|---|---|---|---|---|
| | | Patients¹ | Patients² | | Controls | Patients | Tumor | Tumors | Tumors |
| Age | | 65.5 ± 11.2 | 67.5 ± 10.9 | | 64.3 ± 8.2 | 69.3 ± 8.3 | 68.3 ± 8.7 | 70.9 ± 8.5 | 74.6 ± 7.6 |
| Gender | Female | 265 | 122 | | 4 | 53 | 40 | 8 | 5 |
| | Male | 426 | 147 | | 7 | 46 | 35 | 6 | 5 |
| Location | Right | 270 | Cecum | 14 | n.a. | 13 | 9 | 3 | 1 |
| | Left | 422 | Ascending | 62 | | 60 | 49 | 7 | 4 |
| | | | Transverse | 27 | | 26 | 17 | 4 | 5 |

| | | | | | | | | |
|---|---|---|---|---|---|---|---|---|
| Stage³ | I | 96 | 46 | n.a. | 23 | 19 | 3 | 1 |
| | II | 200 | 96 | | 54 | 43 | 4 | 7 |
| | III | 193 | 82 | | 22 | 13 | 7 | 2 |
| | IV | 62 | 27 | | 0 | 0 | 0 | 0 |
| MSI | MSS | n.a. | n.a. | n.a. | 75 | 56 | 12 | 7 |
| | MSI | | | | 24 | 19 | 2 | 3 |

| | | | | | | |
|---|---|---|---|---|---|---|
| Follow-up⁴ | n.a. | n.a. | n = 79 | n = 69 | n.a. | n = 10 |
| (Interval in months | | | (6-100) | (28-100) | | (6-83) |

¹Numbers do not add because there were cases without information: 3 for gender, 2 for location and 143 for stage.
²Similarly, 1 case had no information for gender, 167 for the precise location in the right colon and 19 for stage.
³Stages I, II, III and IV refer to Dukes' A, B, C and D.
⁴Mean follow-up was 24 months.
n.a. Not applicable.

Next, a prospective study of patients that developed metachronous tumors was designed, to independently validate the findings with the synchronous cancer patients and to test the predictive value of the NCMs RDL. 196 initially eligible patients from the entire series yielded 126 with informative follow-up. 27 were excluded because of development of metastases from the primary tumor, or death, and 14 and 6 were excluded because of presence of left-side metachronous or extra colonic neoplasms, respectively. Of the remaining sample 10 patients developed right-side metachronous neoplasms in the follow-up period, while 69 patients showed no evidence of metachronous tumors.

### MS-AFLP DNA Fingerprinting

Hypomethylation alterations were identified by methylation-sensitive amplification length polymorphism (MS-AFLP) in a panel of 77 colorectal tumors and matching normal tissues (Suzuki et al., 2006). The mutational status of several genes (TP53, KRAS and BRAF) was determined in these tumor samples.

### RDL Assay

Samples from colon cancer patients were obtained from the Saitama Medical Center, Jichi Medical University, Saitama, Japan. After surgical resection, tissue specimens were immediately soaked in RNAlater (Ambion; Austin, Tex.) and stored at −80° C. after the RNAlater solution was removed. Before DNA preparation, the dissected tissue was placed in buffered proteinase K solution at 56° C. for 3 h. Genomic DNA was isolated and purified using a BioRobot EZ1 workstation and an EZ1 DNA tissue kit (Qiagen, Hilden, Germany) according to the manufacturer's instructions. FAM: 6-carboxyfluorescein (fluorophore). MGB: dihydrocyclopyrroloindole tripeptide minor groove binder (quencher).

Relative demethylation level (RDL) was estimated by quantitative PCR of demethylated LINE-1 elements amplified from isulfate-treated genomic DNA. LINE-1 RDL represents the proportion of completely demethylated LINE-1 elements in the analyzed sample relative to a reference sample. ALU sequences are employed for normalization. Primers are listed in Table 2 below:

TABLE 2
Primers and conditions for LINE-1 RDL assay.

| Reaction | Primers and internal probe |
|---|---|
| LINE-1 | 5′-TTTATTAGGGAGTGTTAGATAGTGGGTG-3′ |
| | 5′-CCTTACACTTCCCAAATAAAACAATACC-3′ |
| | FAM-TACTTCAACTCATACACAATAC-MGB |
| ALU | 5′-GGTTAGGTATAGTGGTTTATATTT |
| (normalization) | GTAATTTTAGTA-3′ |
| | 5′-ATTAACTAAACTAATCTTAAACTC |
| | CTAACCTCA-3′ |
| | FAM-CCTACCTTAACCTCCC-MGB |

Thermal cycling

| 1 cycle | 50 cycles | |
|---|---|---|
| 95° C. | 95° C. | 60° C. |
| 10 seconds | 5 seconds | 30 seconds |

LINE-1 RDL Calculation
$LINE 1 RDL = \frac{{( \frac{LINE {1}_{reaction}}{{ALU}_{reaction}} )}_{sample}}{{( \frac{LINE {1}_{reaction}}{{ALU}_{reaction}} )}_{reference}}$

| Precision estimations* | LINE-1 reaction | ALU reaction |
|---|---|---|
| Within-run | 0.47% | 0.9% |
| Between-runs | 2.3% | 2.1% |

Human DNA from lymphocytes was used as reference. Precision estimations were calculated independently for the LINE-1 and ALU reactions as the ratio of the standard deviations of the threshold cycles (Ct) divided by the mean of the Ct using 3-5 examinations. MSI was determined as described (Suzuki et al., 2003; Suzuki et al., 2006).

### DNA Hypomethylation and a “Wear and Tear” Model for Colon Cancer

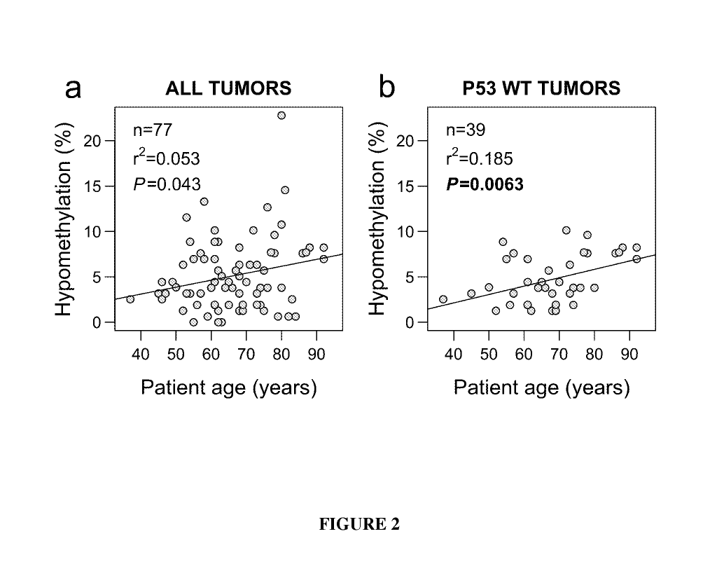

The present invention now describes that the tendency of demethylation to increase with aging was more evident in those CC patients harboring wild type p53 (FIG. 2). The association between patient age and hypomethylation alterations did not exhibit substantial changes when the samples were stratified according to the mutational status of KRAS or BRAF (not shown).

### DNA Hypomethylation in Healthy Individuals Compared to CC Patients

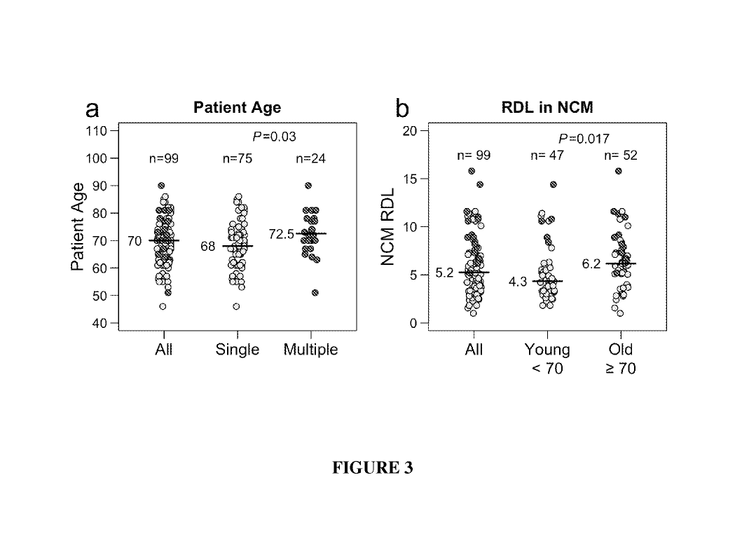

The extent of methylation in the normal tissue of CC patients, as well as in healthy volunteers, was analyzed to determine whether the degree of demethylation in normal tissues could distinguish healthy individuals from CC patients. A relative demethylation level (RDL) assay of LINE-1 repetitive sequences was employed using the MethyLight approach (Weisenberger et al., 2005) as a surrogate for global demethylation levels. A prospective study with a cohort of CC patients was designed with a seven year follow-up. Of the 196 patients eligible for follow-up, 99 were analyzed for RDL in NCM. When RDL was correlated with patient age, demethylation of NCM appeared higher in older CC patients when the total patient sample was considered (P=0.017) (FIG. 3b).

DNA Demethylation in NCM Associates with Synchronous Colon Cancer

Next, the RDL of NCM from healthy individuals was compared with that of CC patients. While no difference in methylation was found in NCM from single CC patients and healthy volunteers, the NCM from synchronous cancer patients showed a higher RDL than from single CCs. Synchronous CCs also displayed a higher RDL than single CCs (Table 3A). Next, it was tested whether the higher demethylation in NCM from patients with synchronous CC also extended to those patients who developed later new (metachronous) tumors after colectomy. It was revealed that the level of demethylation of the NCMs from the initial surgery correlated with the risk to develop metachronous tumors (Table 3B).

TABLE 3
LINE-1 Methylation data in right sided colon cancer patients.
A

| | Single | Synchronous | |
|---|---|---|---|
| LINE-1 RDL | (n = 32) | (n = 14) | P-value |
| CANCER (CC) | 34.3 ± 17.3 | 59.5 ± 25.0 | 1.4 × 10⁻³ |
| NORMAL | 5.0 ± 2.5 | 9.1 ± 2.7 | 1.1 × 10⁻⁵ |
| (NCM) | | | |

B

| | Single | Metachronous | |
|---|---|---|---|
| LINE-1 RDL | (n = 69) | (n = 10) | P-value |
| NORMAL | 4.7 ± 2.8 | 7.6 ± 3.4 | 0.013 |
| (NCM) | | | |

LINE-1 relative demethylation level (RDL) in primary colon carcinoma (CC) and normal colonic mucosa (NCM) patients with right-sided CCs (A), and from patients with and without metachronous right-sided colon adenomas or carcinomas in patients with previous right sided colon cancer and without metastatic spread or metachronous neoplasms in the distal colon or extracolonic neoplasms (see FIG. 1), during a follow-up period of 100 months (B). The RDL values from NCMs of 11 healthy volunteers was 4.7±2.8. (P=0.50 healthy vs. single CCs and P=0.0008, healthy vs. synchronous CCs). P-values were calculated by Mann-Whitney-Wilcoxon rank-sum test. NCM samples were obtained from the initial surgery of all patients.

DNA Demethylation in NCM and MSI

All patients with family history of CC were excluded because MSI is the landmark of HNPCC wherein the affected members are at high risk for developing synchronous and metachronous CC. In addition, the negative association of high demethylation with MSI adds further evidence that the described phenomenon linking demethylation with risk for synchronous and metachronous neoplasms is not due to undetected HNPCC patients. MSI CC due to defective DNA mismatch repair has distinct isulf-pathological features, including proximal colon predominance, quasi-diploid DNA content, poor differentiation, less advanced stage of progression and better survival (Ionov et al., 1993; Thibodeau et al., 1993; Kim et al., 1994; Perucho, 1996; Vilar and Gruber, 2010). Disclosed herein is additional evidence that the colorectal cancer pathway followed by MSI tumors differs from the rest of cancers without MSI: while no difference was found in methylation levels of NCM from patients with or without MSI (FIG. 2b), MSI cancers displayed more demethylation (lower RDL) than cancers without MSI (FIG. 2a). This lower degree of demethylation in MSI cancers compared with MSS cancers was however higher than the level in normal tissue, showing that extensive demethylation in precursor colon cancer cells also takes place before the manifestation of the mutator phenotype. This is based on the fact that the somatic changes taking place after neoplastic transformation are relatively minor compared to those occurring before, in the normal precursor cells of MSI tumors (Tsao et al., 2000). The staggering amount of somatic mutations in microsatellite sequences (hundred of thousands) accumulated by these MSI tumors also argues strongly that these clonal mutations accumulate before transformation (Ionov et al., 1993).

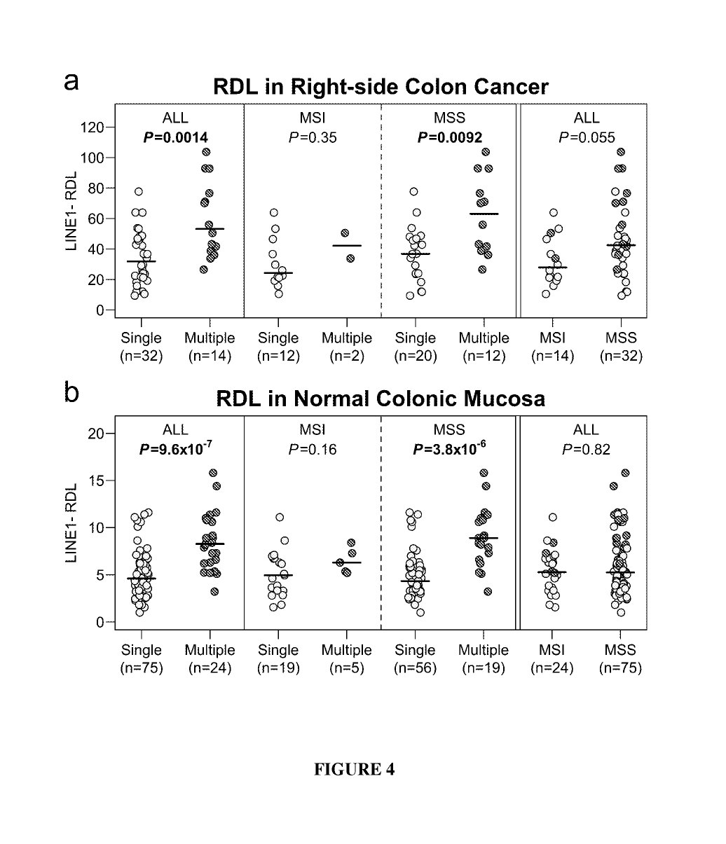

The data for synchronous cancers was then combined with metachronous tumors (i.e. ‘multiple’ tumors, FIG. 4). The differences in demethylation level between single and multiple tumors (P=9.6×10⁻⁷) remained extremely significant (P=3.8×10⁻⁶) after filtering out the patients with microsatellite instability (MSI) cancer both in tumor (FIG. 4a) and in NCM (FIG. 4b). MSI positive cancers displayed less demethylation than those without MSI (FIG. 4a, right). In contrast, no differences in methylation levels were apparent in NCMs from patients with CC with or without MSI (FIG. 4b, right). Therefore, the results exclude the association of multiple tumors with MSI and hence with HNPCC.

### DNA Demethylation in NCM Predicts Development of Metachronous Colon Tumors

During the follow-up period 10 patients developed a metachronous tumor and 69 patients did not. Of the 10 patients with metachronous neoplasms, four developed carcinomas and six adenomas (Table 4).

TABLE 4
LINE-1 Relative demethylation levels (RDL) of normal colonic mucosae (NCM) and
clinicopathological features of 10 right-sided colon cancer patients with
postoperative metachronous neoplasms on the right-sided colonic remnant.

| | | Primary | | | | | | Metachronous | | | | |
|---|---|---|---|---|---|---|---|---|---|---|---|---|
| Case | Age/Sex | Loc¹ | Differ² | Invas³ | Stage⁴ | RDL | MSI | I⁵ | Loc¹ | Type⁶ | Characteristics⁷ | Type of surgery⁸ |
| M1 | 67/M | A | well | SM | I | 5.3 | − | 11 | T | a | Isp, 10 mm, | R colectomy |
| | | | | | | | | | | | mod | |
| M2 | 78/F | C | muc | SS | II | 5.4 | + | 39 | T | c | MP | Ileocecal resect. |
| M3 | 81/F | T | well | SS | II | 7.3 | + | 25 | A | a | Isp, 10 mm, | T colectomy |
| | | | | | | | | | | | mod | |
| M4 | 74/M | T | well | SS | II | 3.2 | − | 12 | T | c | MP | T colectomy |
| M5 | 70/F | A | well | SS | II | 8.4 | − | 83 | T | a | Iia, 12 mm, | R colectomy |
| | | | | | | | | | | | mod | |
| M6 | 72/F | T | well | SS | II | 9.2 | − | 6 | A | a | Isp, 7 mm, | T colectomy |
| | | | | | | | | | | | mod | |
| M7 | 90/M | A | well | SS | II | 11.4 | − | 13 | T | c | SM | Ileocecal resect. |
| M8 | 63/F | T | well | SS | II | 14.4 | − | 34 | T | a | Isp, 7 mm, | T colectomy |
| | | | | | | | | | | | mod | |
| M9 | 74/M | A | well | SS | III | 6.3 | + | 17 | T | c | MP | R colectomy |
| M10 | 77/M | T | well | MP | III | 5.1 | − | 26 | T | a | Isp, 7 mm, | T colectomy |
| | | | | | | | | | | | sev | |

¹Location: C, cecum; A, ascending; T, transversal colon.
²Differentiation: well, moderately, mucinous.
³Invasion depth: MP, muscularis propria; SM, submucosal layer; SS, subserosal layer.
⁴Stage according to Dukes' classification.
⁵Interval after initial surgery to diagnose a metachronous neoplasm (months).
⁶Adenoma (a); Carcinoma (c).
⁷Macroscopic findings: Isp, semi-pedinculated; Iia, flat-elevated. Size (in mm). Degree of atypia, severe, moderate.
⁸NCM samples were usually taken 10 cm apart from the tumor margin.

Since only 4 carcinomas were insufficient to perform statistical comparisons, the four carcinomas were grouped with the six adenomas (Table 3), because advanced adenomas exhibit a high risk of progressing into carcinomas and are regularly removed.

Univariate logistic regression analyses were performed to determine the association between several factors (patient age, gender, tumor location, invasiveness, MSI status and RDL levels in NCM) with the probability of developing a metachronous tumor independently. The univariate logistic regression analyses revealed that the only factors with statistical significance were patient age (P=0.026) and RDL levels in the NCM (P=0.010). A multivariate logistic regression analysis including all these factors together demonstrated that the only factor that retained statistical significance was demethylation in NCM (P=0.0254). A backward-elimination stepwise logistic regression yielded a best-fitting model containing only patient age and demethylation as predictors of metachronous tumor development. In this model the only factor maintaining the statistical significance (P=0.028) was demethylation of normal mucosa (Table 5A).

In a similar approach, the association between these factors and the probability of developing a multiple tumor, either synchronous or metachronous, was analyzed. For this analysis, the data from 75 patients with single CC, 14 patients with double synchronous CC and 10 patients who had a single CC and developed metachronous tumors in the follow-up period was employed. In the univariate logistic regression analyses, three of these factors were statistically significant: patient age (P=0.036), invasiveness (P=0.043) and RDL in NCM (P=1.9×10⁻⁵). The multivariate logistic regression analysis showed that, as it happened in the previous study, demethylation of the NCM was the only factor retaining statistical significance (P=5.8×10⁻⁵). The best-fitting model obtained after backward-elimination stepwise logistic regression contained patient age, invasiveness and RDL in NCM as predictors of multiple tumors. In this model, once again, RDL in NCM was the only factor maintaining statistical significance (P=4.9×10⁻⁵) associated to the development of multiple tumors (Table 5B).

TABLE 5
Univariate and multivariate logistic regression analysis.

| | Univariate Logistic | | Multivariate Logistic | | Stepwise Logistic | |
|---|---|---|---|---|---|---|
| | Regression | | Regression | | Regression | |
| Factor | Coefficients | P-value | Coefficients | P-value | Coefficients | P-value |

A

| | | | | | | |
|---|---|---|---|---|---|---|
| Age | 0.102 | 0.0262 | 0.071 | 0.01476 | 0.082 | 0.0793 |
| Gender | 0.087 | 0.8980 | 0.662 | 0.4154 | excluded | |
| (M vs F) | | | | | | |
| Location | 1.118 | 0.1060 | 0.983 | 0.2096 | excluded | |
| (C + A vs T) | | | | | | |
| Stage | 0.276 | 0.7470 | 0.253 | 0.8018 | excluded | |
| (I + II vs III) | | | | | | |
| MSI | −0.271 | 0.7161 | −0.456 | 0.5930 | excluded | |
| (MSI vs MSS) | | | | | | |
| RDL in NCM | 0.299 | 0.0104 | 0.306 | 0.0254 | 0.276 | 0.0284 |

B

| | | | | | | |
|---|---|---|---|---|---|---|
| Age | 0.064 | 0.0367 | 0.052 | 0.1753 | 0.061 | 0.0992 |
| Gender | −0.034 | 0.9432 | 0.121 | 0.8387 | excluded | |
| (M vs F) | | | | | | |
| Location | −0.716 | 0.1550 | 0.848 | 0.1836 | excluded | |
| (C + A vs T) | | | | | | |
| Stage | 1.051 | 0.0434 | 1.115 | 0.0937 | 1.050 | 0.1057 |
| (I + II vs III) | | | | | | |
| MSI | 0.254 | 0.6549 | 0.059 | 0.9306 | excluded | |
| (MSI vs MSS) | | | | | | |
| RDL in NCM | 0.442 | 1.9E−05 | 0.484 | 5.8E−05 | 0.472 | 4.9E−05 |

Patients with more demethylation (higher RDL) in NCM at time of surgery developed more metachronous tumors during the follow-up period (FIG. 5 and Table 4).

DNA Demethylation and Age of Patients with Multiple Colon Tumors

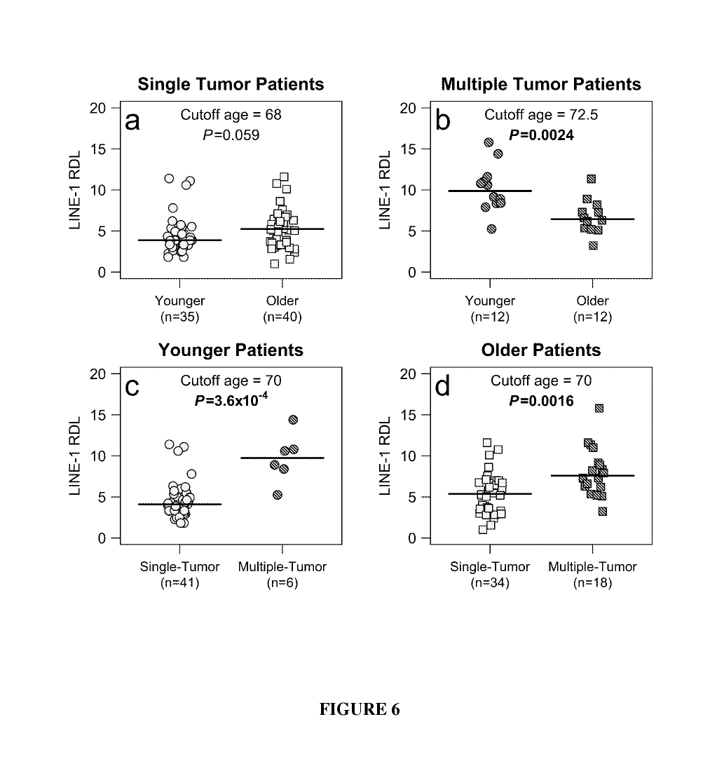

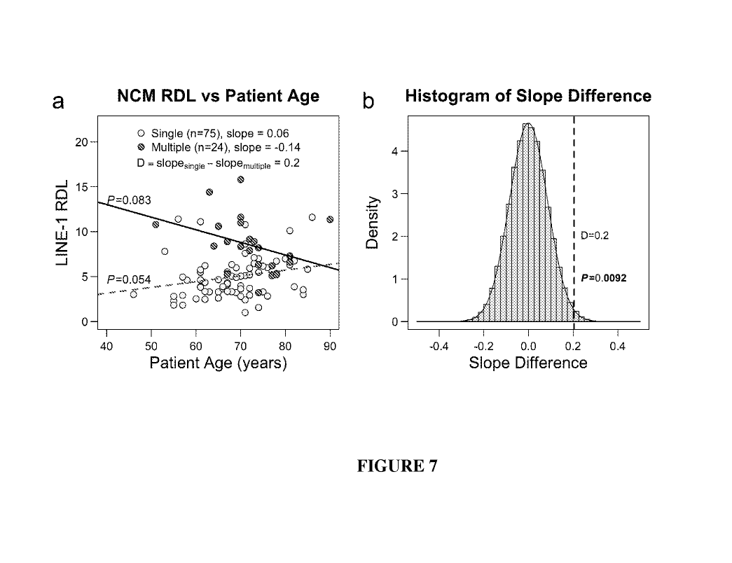

Patients with multiple tumors were older than patients with single tumors (68.3±8.3 vs. 72.5±7.8, P=0.03). When considered into groups of single and multiple tumors, there was more demethylation (higher RDL) in older patients in the single tumor group (FIG. 6a), but less demethylation in older patients with multiple neoplasms (FIG. 6b). The difference in demethylation between patients with single versus multiple tumors seemed to be more significant in younger (FIG. 6c) than older (FIG. 6d) patients. Furthermore, the slopes of the RDL values in relation to aging were inverse, showing that demethylation in NCM increased with aging in patients with single tumors, but decreased in those with multiple tumors (FIG. 7).

Multivariate analysis showed that demethylation was the only independent significant predictor of outcome. When introducing age and RDL as continuous variables in stepwise logistic regression analyses the best fitting models retained RDL and age, with P-values of P=0.028 (RDL) and P=0.079 (age) for metachronous tumor development, and P=4.2×10⁻⁵ (RDL), P=0.099 (age) and P=0.106 (stage) for synchronous plus metachronous tumors. However, in other regression analyses whereby age and RDL were considered as categorical variables, age was excluded using different cutoffs and instead anatomical location remained in the best fitting model together with RDL, although again, demethylation was the only significant factor (data not shown). Therefore, in one aspect, this data suggests that age is not a risk factor for future neoplasm development in the proximal colon. That conclusion is consistent with the data: while demethylation increased with age in patients with single cancers, the cases with multiple tumors (metachronous and synchronous), while older overall than the entire patient population, were relatively ‘younger’—(i.e., less than 70 years of age) (FIG. 6 and FIG. 7a).

Results indicate that the individuals with demethylation levels above the continuous accumulation of background demethylation errors during aging represent a distinct subgroup of relatively younger individuals with a propensity to develop metachronous neoplasms in the proximal colon.

The association of demethylation not only in tumor tissue, but also in normal colon tissue of colon cancer patients with multiple tumors provides mechanistic insights for the origins of the enhanced demethylation and is consistent with a role of demethylation in a long range field cancerization (Table 6).

TABLE 6
LINE-1 relative demethylation level (RDL) in the tumor (T) and NCM
samples obtained at increasing distances from the tumor.

| Case | | | | LINE-1 RDL^{a} | | | | | |
|---|---|---|---|---|---|---|---|---|---|
| No | Age/sex | Stage | MSI | N2 | N4 | N6 | N8 | N10 | T^{b} |
| E1 | 81/F | I | + | 4.7 | 5.8 | 6.3 | 5.2 | 5.4 | 10.5 |
| E2 | 71/M | II | + | 4.4 | 4.9 | 4.1 | 4.5 | 5.1 | 26 |
| E3 | 67/F | II | − | 5.6 | 4.8 | 4.1 | 5.7 | 3.8 | 64 |
| E4 | 63/F | II | − | 4.8 | 3.3 | 3.2 | 4.3 | 2.2 | 48 |
| E5 | 58/F | III | − | 4.3 | 4.9 | 4.1 | 4.6 | 5.1 | 42.2 |
| E6 | 84/M | III | − | 3 | 3.8 | 3.5 | 2.5 | 2.1 | 23.6 |

LINE-1 relative demethylation levels were determined at different locations of the colonic mucosa of colon cancer patients, taking samples increasingly further away from the primary tumor (N2 to N10, representing samples 2 to 10 cm away from the tumor). In three out of six samples (E3, E4 and E6), a decrease in the levels of demethylation is observed, i.e. the demethylation is lower the further away from the primary lesion. All these three samples are MSS. In the other three samples (E1, E2 and E5), comprising 2 MSI and 1 MSS case, the LINE-1 demethylation levels remain constant throughout the studied area of the colonic mucosa.

Candidates for the origin of demethylation may include genetic or epigenetic defects in nuclear factors involved in the replication of somatic methylation, including the methyl transferases and their associated proteins.

### Statistical Analyses

Statistical analyses were performed using R Environment for Statistical Computing software (R Development Core Team, 2009). Correlation between continuous variables was analyzed using the Pearson's product-moment correlation test. Differences between groups were analyzed by the non-parametric Mann-Whitney-Wilcoxon rank-sum test for those variables not following a normal distribution (RDL) or by Student's t-test for those variables following a normal distribution (patient age). Deviation from normality was assessed using the Shapiro-Wilk normality test. Differences in metachronous tumor incidence during the follow-up period was studied using the logrank test. The significance of associations was analyzed using Fisher's exact tests for 2×2 contingency tables or by Chi-squared test for larger dimension contingency tables.

### Example 2

### SATα RDL in the NGM from Patients with Synchronous Double Gastric Cancer

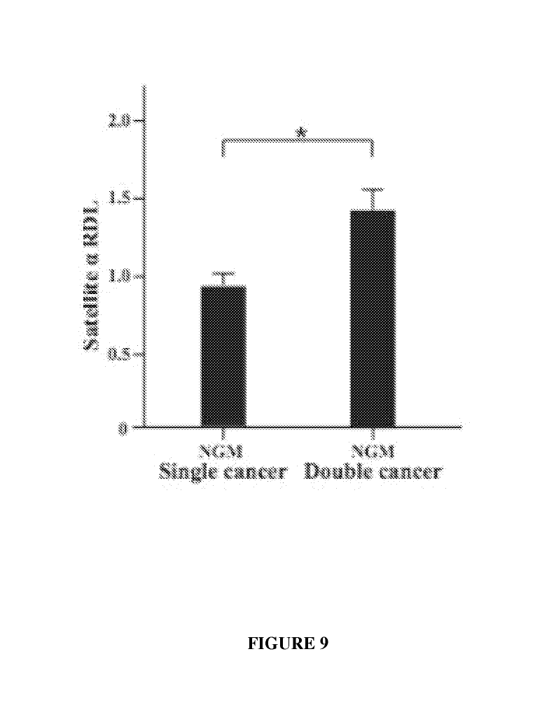

The present invention shows that multi-cancer development of the stomach are affected by accelerated demethylation in the region of the stomach. The present invention indicates that the SAT α RDL in the NGM are significantly elevated in patients with synchronous double GC compared with single GC (FIG. 9: 1.545±0.236 in double vs. 1.018±0.071 in single, P=0.006).

Multivariate analyses revealed that SAT α RDL in the NGM was an independent factor to predict the existence of multiple tumors. The present invention can be used as an independent predictive biomarker for the existence of multiple tumors in the stomach using a biomarker SAT α RDL in the NGM. To verify the independence of SAT α RDL in the NGM as a biomarker able to predict the existence of multiple cancers, multivariate analyses were performed, which revealed that the age, the diffuse type of differentiation, and SAT α RDL in the NGM were independent factors to predict the existence of multiple tumors (Table 7: Age odds ratio=1.080, P=0.008, differentiation odds ratio=9.321, P=0.001 SAT a RDL in the NGM odds ratio=5.690, P=0.008). In further analyses that excluded the diffuse-type, the age and SAT α RDL in the NGM were independent factors to predict the existence of multiple tumors in intestinal type GC (Table 7: Age odds ratio=1.203, P=0.030, P=0.001 SAT α RDL in the NGM odds ratio=7.899, P=0.003).

TABLE 7
Multivariate analyses to predict the existence of multiple gastric cancers.

| | | Odds | 95% | |
|---|---|---|---|---|
| Factors | Variables | ratio | Confidence limits | P-Value |
| Age | | 1.080 | 1.020-1.144 | 0.008 |
| Gender | Female* vs. Male | 2.440 | 0.569-10.462 | 0.230 |
| Depth | (m/sm/mp)* vs. (ss/se) | 0.667 | 0.161-2.761 | 0.576 |
| LN meta | Negative* vs. positive | 0.299 | 0.082-1.089 | 0.067 |
| Diff | Intestinal* v. diffuse | 9.321 | 2.374-36.597 | 0.001 |
| RDL | =<1.5* + vs. >1.5 | 5.690 | 1.559-20.776 | 0.008 |

Differentiation and RDL were significant variables to predict the presence of double cancers among several clinical, pathological, and genetic factors.
Depth: depth of invasion;
m: mucosa,
sm: submucosa,
mp: muscularis propria,
subserosa or serosa exposed,
LN: lymph node metastasis,
RDL: relative demethylation level with cut-off of 1.5.

### Patients and Specimens

Samples of the non-cancerous gastric mucosa (NGM) analyzed in this study were obtained from 165 healthy volunteers (83 Helicobacter pylori-positive and 82-negative individuals) who underwent upper gastrointestinal endoscopy at an affiliated hospital of the Saitama Medical Center, Jichi Medical University, Japan. Samples of the NGM were collected by endoscopic biopsy of the pyloric region of the stomach. Tumor tissues and corresponding normal gastric mucosae were also obtained from 83 patients with single gastric cancer (GC) and 18 patients with synchronous double GC (Table 1) who underwent curative surgery from May 2001 to December 2010 at the Saitama Medical Center, Jichi Medical University, Japan.

TABLE 8
Clinicopathological features of 83 patients with single gastric cancer
patients and 18 patients with double gastric cancer patients.

| | Single | | |
|---|---|---|---|
| | gastric cancer | Double gastric cancer | |
| Parameter | patients (n = 83) | patients (n = 18) | P value |
| Mean age (±SD) | 64.1 ± 12.4 | 71.2 ± 7.8 | 0.022 |
| Sex (Male/Female) | 59/24 | 15/3 | 0.290 |
| Diff | 63/20 | 7/11 | 0.002 |
| (Intestinal/Diffuse) | | | |
| Depth | 14/34/33/2 | 3/11/4/0 | 0.625 |
| (T1/T2/T3/T4) | | | |
| Location (U/M/L) | 20/21/42 | 5/6/7 | 0.652 |
| LN meta | 22/61 | 8/10 | 0.131 |
| (Negative/Positive) | | | |
| ly (0/1/2/3) | 11/24/34/14 | 2/7/7/2 | 0.836 |
| v (0/1/2/3) | 15/27/25/16 | 1/8/7/2 | 0.395 |
| Mean Satellite α | 1.02 ± 0.07 | 155 ± 0.24 | 0.025 |
| RDL (±SD) | | | |

Depth: depth of invasion,
T1: mucosal or submucosal,
T2: muscularis propria,
T3: subserosa,
T4: serosa exposed,
U: upper body of the stomach,
M; middle body,
L: lower body,
Diff: types of differentiation,
LN meta: lymph node metastasis;
ly: degree of lymphatic infiltration;
v: degree of venous infiltration.

### DNA Extraction and Isulfate Modification

The sodium isulfate conversion of genomic DNA was performed using an Epitect Bisulfite Kit (QIAGEN, Hilden, Germany). DNA quantities of 1 μg in aα volume of up to 40 were processed using this standard protocol. The treatment of genomic DNA with sodium isulfate converted unmethylated (not methylated) cytosine to uracil, which was then converted to thymidine during subsequent PCR steps. This process revealed the sequence differences between the methylated and unmethylated DNA.

### Determination of Methylation by MethyLight Methods

After isulfate modification, each sample was examined using MethyLight technology for duplicate Alu, LINE-1, and satellite-α (SAT α) sequences. MethyLight data are reported as a relative level between the values derived from the real-time PCR standard curve, and plotted as log (quantity) versus threshold cycle (Ct) value for the unmethylated reaction as well as for a methylation-independent control reaction. Whole Genome Amplification Method provided us fully unmethylated DNA obtained from Peripheral blood leukocyte (PBL) DNA, which served as the demethylation constant reference that enabled determination of the relative demethylation level. The RDL was defined as (Alu, LINE-1 or SAT α reaction/ALU-C reaction) sample/(Alu, LINE-1 or SAT α reaction/ALU-C reaction) fully unmethylated control DNA.

### Statistical Analyses

All statistical analyses were performed using the Stat View version 5.0 software program (SAS Institute, Cary, N.C.) and the statistical software SPSS version 20.0 (SPSS, Inc., Chicago, Ill., USA). Continuous variations were expressed as the mean±standard error. When necessary, the differences in qualitative variables were evaluated using either the chi-square test or Fisher's exact test. Continuous variables were compared using analyses of variance (ANOVA) with a post hoc test and Student's t-test. All reported P values were two-sided, and P values<0.05 were considered to represent a statistically significant result.

Comparison of SAT α RDL in the NGM between single and synchronous double GC patients: SAT α RDL in the NGM was significantly higher in patients with synchronous double GC compared with those with single GC. *P<0.05

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for diagnosing, predicting, and/or monitoring the status or outcome of a neoplasm or a cancer in a subject in need thereof, comprising:
(a) a computer processing device, optionally connected to a computer network; and
(b) a software module executed by the computer processing device to compare the relative demethylation level (RDL) of a genomic DNA repeat sequence of non-tumoral tissue to a standard or control.

2. The system of claim 1, further comprising a primer complementary to a methylated or unmethylated sequence of a genomic DNA repeat sequence, wherein the primer sequence optionally reflects nucleotide conversion from isulfate treatment; or a probe complementary to a methylated or unmethylated sequence of a genomic DNA repeat sequence, wherein the probe sequence optionally reflects nucleotide conversion from isulfate treatment.

3. The system of claim 1, further comprising a computer model or algorithm for analyzing the relative demethylation level (RDL) of the genomic DNA repeat sequence in non-tumoral tissue from the subject.

4. The system of claim 1, further comprising a software module for generating a patient report wherein the patient report comprises a representation of the RDL level of the genomic DNA repeat sequence.

5. The system of claim 4, wherein the patient report comprises raw data, a diagnosis, a likelihood score, and/or a recommendation for surveillance or a therapeutic regimen.

6. The system of claim 1, further comprising non-tumoral tissue from the subject.

7. The system of claim 1, wherein the genomic DNA repeat sequence is selected from the group consisting of: LINE-1, Sat-α, and SSTI.

8. The system of claim 1, further comprising a computer model or algorithm for correlating RDL level with a disease state or outcome.

9. The system of claim 1, wherein the disease state or outcome is the probability of synchronous or metachronous tumors.

10. The system of claim 1, further comprising a computer model or algorithm for designating a surveillance regime or treatment modality for the subject.

11. The system of claim 1, further comprising a computer readable medium for recording and storing the RDL levels.

12. The system of claim 1, further comprising a computer model or algorithm for normalizing the RDL of the genomic DNA repeat sequence.

13. The system of claim 1, further comprising a readable storage media comprising instructions executed by a computer device to compare the RDL levels to a control.

14. The system of claim 1, further comprising a computer system for transmitting a result to the subject and/or healthcare provider.

15. The system of claim 1, further comprising at least one device for detecting or quantifying the RDL levels.

16. The system of claim 1, further comprising a device for directly detecting, quantifying, and/or amplifying the genomic DNA repeat sequence.

17. The system of claim 1, further comprising a device that is a sequencer or electrophoresis apparatus.

18. The system of claim 17, wherein the sequencer comprises single-molecule sequencing or bead-array technologies.

19. The system of claim 1, further comprising a device that extracts the genomic DNA repeat sequence from the non-tumoral tissue.

20. The system of claim 1, further comprising a computer module to combine the RDL with analysis of the age of the subject.
